(19) United States
(12) Patent Application Publication
(10) Pub. No.: US 2024/0073994 A1
(43) Pub. Date: Feb. 29, 2024

(54) A RAPID SIGNALING RELEASE SOLUTION AFTER PAGING RESPONSE

(71) Applicant: QUALCOMM INCORPORATED, San Diego, CA (US)

(72) Inventors: Juan ZHANG, Beijing (CN); Miguel GRIOT, La Jolla, CA (US)

(21) Appl. No.: 18/256,627

(22) PCT Filed: Feb. 10, 2021
(86) PCT No.: PCT/CN2021/076560

§ 371 Date: Jun. 8, 2023

(51) Int. Cl. H04W 76/30; H04W 68/00

(52) U.S. Cl. CPC H04W 76/30; H04W 68/005

(57) ABSTRACT

Methods, systems, and devices for wireless communications are described. A user equipment (UE) may transmit a first control message to a radio access network (RAN) node which requests termination of paging by the core network. The RAN node may forward the first control message to the core network, and the core network may transmit a first non-access stratum (NAS) message including a reallocation of a temporary identifier associated with the paging message, and a set of release assistance parameters to the RAN. The set of release assistance parameters may notify the RAN to trigger a service release upon re-reallocation of the temporary identifier to the UE, and the UE may transmit the second uplink NAS message to the RAN. Based on receiving the second NAS message, the RAN may trigger the service release of the UE.

### CROSS REFERENCE

The present Application is a 371 national stage filing of International PCT Application No. PCT/CN2021/076560 by ZHANG et al. entitled “A RAPID SIGNALING RELEASE SOLUTION AFTER PAGING RESPONSE,” filed Feb. 10, 2021, which is assigned to the assignee hereof, and which is expressly incorporated by reference in its entirety herein.

### FIELD OF TECHNOLOGY

The following relates to wireless communications, including a rapid signaling release solution after paging response.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations or one or more network access nodes, each simultaneously supporting communication for multiple communication devices, which may be otherwise known as user equipment (UE).

A wireless communications network may implement paging procedures to periodically notify UEs of data to receive. To receive a paging message, the UE may transition from an idle or inactive mode to a connected mode, or the UE may pause ongoing communications. In some cases, the UE may determine to reject the paging procedure by responding to the paging message with a busy indication to release the connection between the UE and the network. Various processes that occur between the UE transmitting the busy indication and release of the UE, however, may be inefficient.

### SUMMARY

The described techniques relate to improved methods, systems, devices, and apparatuses that support a rapid signaling release solution after paging response. Generally, the described techniques provide for increased efficiency and reduced latency associated with a busy indication procedure, among other paging or signaling processes between a user equipment (UE) and a network entity. In some wireless communications networks, a core network node may transmit a paging message associated with the first UE identifier to the UE. In some cases, the UE may reject the paging message by transmitting a paging response such as a busy indication message, and the core network node may perform a UE identifier reallocation in a procedure to terminate the paging. Such reallocation procedures, along with other subsequent paging termination and UE release processes, however, may be inefficient.

In some cases, upon receiving a busy indication from the UE, the core network may transmit a first non-access stratum (NAS) accept message to a radio access network (RAN) which acknowledges termination of the paging, and indicates a second temporary identifier (e.g., a reallocation of a first temporary identifier associated with the paging message) along with additional release assistance parameters. In some examples, the release assistance parameters may notify the RAN that it may release its connection with the UE after receiving an uplink NAS message from the UE that acknowledges the reallocation of the first temporary identifier. The RAN may relay the first NAS message to the UE, and the UE may transmit a second uplink NAS message to the RAN to acknowledge the receipt of the second temporary identifier. Based on the second uplink NAS message, the UE may receive a radio resource control (RRC) release message which releases the UE from connection with the network.

A method for wireless communications at a UE is described. The method may include transmitting, to a radio access network node, a first control message indicating a request to terminate a paging procedure at the UE, the first control message associated with a first temporary identifier for the UE, receiving, from the radio access network node, a first non-access stratum message including both an acknowledgement of the request to terminate the paging procedure in response to the first control message and an indication of a reallocation of the first temporary identifier for the UE, transmitting, to the radio access network node and in response to the first non-access stratum message, a second non-access stratum message indicating receipt of the reallocation of the first temporary identifier, and receiving, from the radio access network node, a second control message indicating a service release of the UE from the radio access network node in response to the second non-access stratum message.

An apparatus for wireless communications at a UE is described. The apparatus may include a processor, memory coupled with the processor, and instructions stored in the memory. The instructions may be executable by the processor to cause the apparatus to transmit, to a radio access network node, a first control message indicating a request to terminate a paging procedure at the UE, the first control message associated with a first temporary identifier for the UE, receive, from the radio access network node, a first non-access stratum message including both an acknowledgement of the request to terminate the paging procedure in response to the first control message and an indication of a reallocation of the first temporary identifier for the UE, transmit, to the radio access network node and in response to the first non-access stratum message, a second non-access stratum message indicating receipt of the reallocation of the first temporary identifier, and receive, from the radio access network node, a second control message indicating a service release of the UE from the radio access network node in response to the second non-access stratum message.

Another apparatus for wireless communications at a UE is described. The apparatus may include means for transmitting, to a radio access network node, a first control message indicating a request to terminate a paging procedure at the UE, the first control message associated with a first temporary identifier for the UE, means for receiving, from the radio access network node, a first non-access stratum message including both an acknowledgement of the request to terminate the paging procedure in response to the first control message and an indication of a reallocation of the first temporary identifier for the UE, means for transmitting, to the radio access network node and in response to the first non-access stratum message, a second non-access stratum message indicating receipt of the reallocation of the first temporary identifier, and means for receiving, from the radio access network node, a second control message indicating a service release of the UE from the radio access network node in response to the second non-access stratum message.

A non-transitory computer-readable medium storing code for wireless communications at a UE is described. The code may include instructions executable by a processor to transmit, to a radio access network node, a first control message indicating a request to terminate a paging procedure at the UE, the first control message associated with a first temporary identifier for the UE, receive, from the radio access network node, a first non-access stratum message including both an acknowledgement of the request to terminate the paging procedure in response to the first control message and an indication of a reallocation of the first temporary identifier for the UE, transmit, to the radio access network node and in response to the first non-access stratum message, a second non-access stratum message indicating receipt of the reallocation of the first temporary identifier, and receive, from the radio access network node, a second control message indicating a service release of the UE from the radio access network node in response to the second non-access stratum message.

Some examples of the method, apparatuses, and non-transitory computer-readable medium described herein may further include operations, features, means, or instructions for initiating the service release of the UE from the radio access network node upon receiving the second control message.

In some examples of the method, apparatuses, and non-transitory computer-readable medium described herein, the first non-access stratum message further includes at least one data packet for the UE and the method, apparatuses, and non-transitory computer-readable medium may include further operations, features, means, or instructions for transmitting, to the radio access network node, the second non-access stratum message indicating receipt of the first non-access stratum message.

In some examples of the method, apparatuses, and non-transitory computer-readable medium described herein, the at least one data packet includes a non-access stratum packet data unit.

In some examples of the method, apparatuses, and non-transitory computer-readable medium described herein, the first non-access stratum message includes a downlink control message.

In some examples of the method, apparatuses, and non-transitory computer-readable medium described herein, the first control message includes a non-access stratum service request message or a non-access stratum control plane service request message.

Some examples of the method, apparatuses, and non-transitory computer-readable medium described herein may further include operations, features, means, or instructions for pausing one or more operations of the UE in accordance with transmitting the first control message and resuming the one or more operations of the UE upon transmitting the second non-access stratum message indicating receipt of the reallocation of the first temporary identifier.

A method for wireless communications at a radio access network node is described. The method may include transmitting, to a core network node, a first control message from a UE indicating a request to terminate a paging procedure at the UE, the first control message associated with a first temporary identifier for the UE, receiving, from the core network node, a first non-access stratum message including a first portion and a second portion, the first portion including both an acknowledgement of the request to terminate the paging procedure in response to the first control message and an indication of a reallocation of the first temporary identifier, the second portion including a set of release assistance parameters associated with triggering a service release of the UE from the radio access network node, relaying, to the UE, the first portion of the first non-access stratum message, receiving, from the UE, a second non-access stratum message in response to the first non-access stratum message indicating receipt of the reallocation of the first temporary identifier, and transmitting, to the UE, a second control message indicating the service release of the UE from the radio access network node in accordance with the set of release assistance parameters and in response to receiving the second non-access stratum message.

An apparatus for wireless communications at a radio access network node is described. The apparatus may include a processor, memory coupled with the processor, and instructions stored in the memory. The instructions may be executable by the processor to cause the apparatus to transmit, to a core network node, a first control message from a UE indicating a request to terminate a paging procedure at the UE, the first control message associated with a first temporary identifier for the UE, receive, from the core network node, a first non-access stratum message including a first portion and a second portion, the first portion including both an acknowledgement of the request to terminate the paging procedure in response to the first control message and an indication of a reallocation of the first temporary identifier, the second portion including a set of release assistance parameters associated with triggering a service release of the UE from the radio access network node, relay, to the UE, the first portion of the first non-access stratum message, receive, from the UE, a second non-access stratum message in response to the first non-access stratum message indicating receipt of the reallocation of the first temporary identifier, and transmit, to the UE, a second control message indicating the service release of the UE from the radio access network node in accordance with the set of release assistance parameters and in response to receiving the second non-access stratum message.

Another apparatus for wireless communications at a radio access network node is described. The apparatus may include means for transmitting, to a core network node, a first control message from a UE indicating a request to terminate a paging procedure at the UE, the first control message associated with a first temporary identifier for the UE, means for receiving, from the core network node, a first non-access stratum message including a first portion and a second portion, the first portion including both an acknowledgement of the request to terminate the paging procedure in response to the first control message and an indication of a reallocation of the first temporary identifier, the second portion including a set of release assistance parameters associated with triggering a service release of the UE from the radio access network node, means for relaying, to the UE, the first portion of the first non-access stratum message, means for receiving, from the UE, a second non-access stratum message in response to the first non-access stratum message indicating receipt of the reallocation of the first temporary identifier, and means for transmitting, to the UE, a second control message indicating the service release of the UE from the radio access network node in accordance with the set of release assistance parameters and in response to receiving the second non-access stratum message.

A non-transitory computer-readable medium storing code for wireless communications at a radio access network node is described. The code may include instructions executable by a processor to transmit, to a core network node, a first control message from a UE indicating a request to terminate a paging procedure at the UE, the first control message associated with a first temporary identifier for the UE, receive, from the core network node, a first non-access stratum message including a first portion and a second portion, the first portion including both an acknowledgement of the request to terminate the paging procedure in response to the first control message and an indication of a reallocation of the first temporary identifier, the second portion including a set of release assistance parameters associated with triggering a service release of the UE from the radio access network node, relay, to the UE, the first portion of the first non-access stratum message, receive, from the UE, a second non-access stratum message in response to the first non-access stratum message indicating receipt of the reallocation of the first temporary identifier, and transmit, to the UE, a second control message indicating the service release of the UE from the radio access network node in accordance with the set of release assistance parameters and in response to receiving the second non-access stratum message.

Some examples of the method, apparatuses, and non-transitory computer-readable medium described herein may further include operations, features, means, or instructions for determining, from the set of release assistance parameters, that the radio access network node may be to initiate the service release of the UE based on receiving the second non-access stratum message.

Some examples of the method, apparatuses, and non-transitory computer-readable medium described herein may further include operations, features, means, or instructions for transmitting, to the core network node, a third non-access stratum message indicating receipt of the reallocation of the first temporary identifier at the UE and indicating the service release of the UE from the radio access network node.

In some examples of the method, apparatuses, and non-transitory computer-readable medium described herein, the first non-access stratum message may be an N2 message from the core network node including the reallocation of the first temporary identifier and the set of release assistance parameters.

In some examples of the method, apparatuses, and non-transitory computer-readable medium described herein, the first non-access stratum message includes at least one data packet for the UE and the method, apparatuses, and non-transitory computer-readable medium may include further operations, features, means, or instructions for receiving, from the UE, the second non-access stratum message indicating receipt of the first non-access stratum message.

In some examples of the method, apparatuses, and non-transitory computer-readable medium described herein, the first non-access stratum message includes a downlink control message.

A method for wireless communications at a core network node is described. The method may include receiving, from a radio access network node, a first control message from a UE indicating a request to terminate a paging procedure at the UE, the first control message associated with a first temporary identifier for the UE, transmitting, to the radio access network node, a first non-access stratum message including a first portion and a second portion, the first portion including both an acknowledgement of the request to terminate the paging procedure in response to the first control message and an indication of a reallocation of the first temporary identifier, the second portion including a set of release assistance parameters associated with triggering a service release of the UE from the radio access network node, and receiving, from the radio access network node, a second non-access stratum message indicating the service release of the UE from the radio access network node in accordance with the set of release assistance parameters and in response to receiving the reallocation of the first temporary identifier.

An apparatus for wireless communications at a core network node is described. The apparatus may include a processor, memory coupled with the processor, and instructions stored in the memory. The instructions may be executable by the processor to cause the apparatus to receive, from a radio access network node, a first control message from a UE indicating a request to terminate a paging procedure at the UE, the first control message associated with a first temporary identifier for the UE, transmit, to the radio access network node, a first non-access stratum message including a first portion and a second portion, the first portion including both an acknowledgement of the request to terminate the paging procedure in response to the first control message and an indication of a reallocation of the first temporary identifier, the second portion including a set of release assistance parameters associated with triggering a service release of the UE from the radio access network node, and receive, from the radio access network node, a second non-access stratum message indicating the service release of the UE from the radio access network node in accordance with the set of release assistance parameters and in response to receiving the reallocation of the first temporary identifier.

Another apparatus for wireless communications at a core network node is described. The apparatus may include means for receiving, from a radio access network node, a first control message from a UE indicating a request to terminate a paging procedure at the UE, the first control message associated with a first temporary identifier for the UE, means for transmitting, to the radio access network node, a first non-access stratum message including a first portion and a second portion, the first portion including both an acknowledgement of the request to terminate the paging procedure in response to the first control message and an indication of a reallocation of the first temporary identifier, the second portion including a set of release assistance parameters associated with triggering a service release of the UE from the radio access network node, and means for receiving, from the radio access network node, a second non-access stratum message indicating the service release of the UE from the radio access network node in accordance with the set of release assistance parameters and in response to receiving the reallocation of the first temporary identifier.

A non-transitory computer-readable medium storing code for wireless communications at a core network node is described. The code may include instructions executable by a processor to receive, from a radio access network node, a first control message from a UE indicating a request to terminate a paging procedure at the UE, the first control message associated with a first temporary identifier for the UE, transmit, to the radio access network node, a first non-access stratum message including a first portion and a second portion, the first portion including both an acknowledgement of the request to terminate the paging procedure in response to the first control message and an indication of a reallocation of the first temporary identifier, the second portion including a set of release assistance parameters associated with triggering a service release of the UE from the radio access network node, and receive, from the radio access network node, a second non-access stratum message indicating the service release of the UE from the radio access network node in accordance with the set of release assistance parameters and in response to receiving the reallocation of the first temporary identifier.

In some examples of the method, apparatuses, and non-transitory computer-readable medium described herein, the set of release assistance parameters indicate that the radio access network node may be to initiate the service release of the UE based on receiving the second non-access stratum message from the UE.

In some examples of the method, apparatuses, and non-transitory computer-readable medium described herein, the first non-access stratum message may be an N2 message including the reallocation of the first temporary identifier and the set of release assistance parameters.

In some examples of the method, apparatuses, and non-transitory computer-readable medium described herein, the first non-access stratum message including the reallocation of the first temporary identifier includes at least one data packet for the UE.

### BRIEF DESCRIPTION OF THE DRAWINGS

FIG. 1 illustrates an example of a wireless communications system that supports a rapid signaling release solution after paging response in accordance with aspects of the present disclosure.

FIG. 2 illustrates an example of a wireless communications system that supports a rapid signaling release solution after paging response in accordance with aspects of the present disclosure.

FIGS. 3 through 6 illustrate examples of process flows that support a rapid signaling release solution after paging response in accordance with aspects of the present disclosure.

FIGS. 7 and 8 show block diagrams of devices that support a rapid signaling release solution after paging response in accordance with aspects of the present disclosure.

FIG. 9 shows a block diagram of a communications manager that supports a rapid signaling release solution after paging response in accordance with aspects of the present disclosure.

FIG. 10 shows a diagram of a system including a device that supports a rapid signaling release solution after paging response in accordance with aspects of the present disclosure.

FIGS. 11 and 12 show block diagrams of devices that support a rapid signaling release solution after paging response in accordance with aspects of the present disclosure.

FIG. 13 shows a block diagram of a communications manager that supports a rapid signaling release solution after paging response in accordance with aspects of the present disclosure.

FIG. 14 shows a diagram of a system including a device that supports a rapid signaling release solution after paging response in accordance with aspects of the present disclosure.

FIGS. 15 through 20 show flowcharts illustrating methods that support a rapid signaling release solution after paging response in accordance with aspects of the present disclosure.

### DETAILED DESCRIPTION

In some wireless communications systems, a user equipment (UE) may be a multi-universal subscriber identity module (MUSIM) UE that may be configured with more than one USIM to securely and efficiently access a wireless network. In some examples, the UE may support communications on one USIM at a time, such that the UE may switch between communications using a first USIM and a second USIM. For example, the UE may establish a connection with the network using the first USIM, and the second USIM may be in an idle or inactive mode. In some cases, however, the UE may receive a paging message on the second USIM, which may pause the ongoing communications on the first USIM while the UE switches from the idle mode to a connected mode on the second USIM to receive the paging message.

In some cases, the UE may determine to reject the paging on the second USIM in order to resume connected mode operations on the first USIM. The UE may reject the paging by sending a busy indication to the network, and the network may perform one or more processes (e.g., between a radio access network (RAN) node and a core network node such as an access and mobility management function (AMF)) to initiate a connection release for the second USIM. Some processes associated with the transmission of the busy indication, however, may have high signaling overhead, and may increase latency for the paused communications on the first USIM.

In some cases, the core network node may allocate a first temporary identifier (e.g., a first global unique temporary identifier (GUTI)) to the UE during an initial registration procedure, and may transmit the paging message with the first temporary identifier. In some examples where the UE rejects the paging using the busy indication, the core network node may perform a temporary identifier reallocation procedure to ensure that future communications between the UE and the network are secure.

Upon receiving a busy indication from the UE, the core network may transmit a first non-access stratum (NAS) accept message to the RAN which indicates a second temporary identifier (e.g., a reallocation of the first temporary identifier) and additional release assistance parameters. In some examples, the release assistance parameters may notify the RAN that it may release its connection with the UE after receiving an uplink NAS message from the UE that acknowledges the reallocation of the first temporary identifier.

The RAN may forward the first NAS accept message to the UE including the second temporary identifier, and the UE may transmit an uplink NAS message to the RAN indicating receipt of the second temporary identifier. Based on receiving the uplink NAS message from the UE, and as indicated by the release assistance parameters, the RAN may transmit a release message (e.g., an RRC release message) to the UE, and the UE may return to an idle or inactive mode on at least one USIM.

Particular aspects of the subject matter described herein may be implemented to realize one or more advantages. The described techniques may support improvements in procedures related to the transmission of a busy indication by the UE. In some examples, the techniques may allow for reduced latency, for example, the UE may resume operations or may return to an idle mode with reduced signaling from the RAN. The described techniques may further reduce signaling overhead, and may simplify a busy indication procedure used to reject paging by the UE. Further, the described techniques may extend battery life of the UE by allowing the UE to more efficiently return to an idle or inactive mode after paging.

Aspects of the disclosure are initially described in the context of wireless communications systems. Aspects of the disclosure are further illustrated by and described with reference to apparatus diagrams, system diagrams, process flows, and flowcharts that relate to a rapid signaling release solution after paging response.

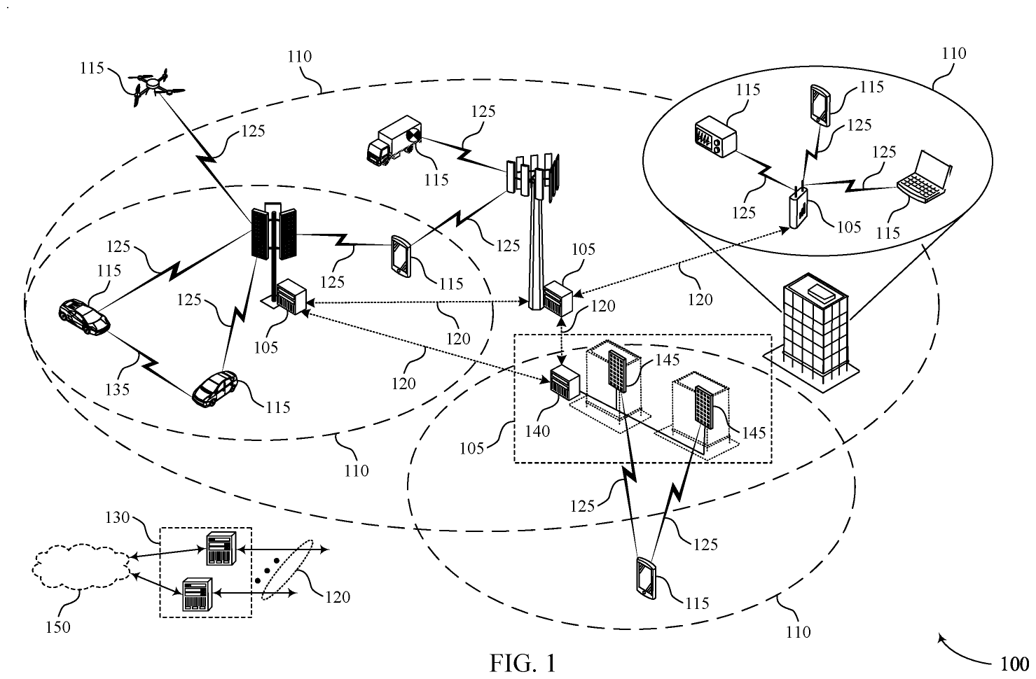

FIG. 1 illustrates an example of a wireless communications system 100 that supports a rapid signaling release solution after paging response in accordance with aspects of the present disclosure. The wireless communications system 100 may include one or more base stations 105, one or more UEs 115, and a core network 130. In some examples, the wireless communications system 100 may be a Long Term Evolution (LTE) network, an LTE-Advanced (LTE-A) network, an LTE-A Pro network, or a New Radio (NR) network. In some examples, the wireless communications system 100 may support enhanced broadband communications, ultra-reliable (e.g., mission critical) communications, low latency communications, communications with low-cost and low-complexity devices, or any combination thereof.

The base stations 105 may be dispersed throughout a geographic area to form the wireless communications system 100 and may be devices in different forms or having different capabilities. The base stations 105 and the UEs 115 may wirelessly communicate via one or more communication links 125. Each base station 105 may provide a coverage area 110 over which the UEs 115 and the base station 105 may establish one or more communication links 125. The coverage area 110 may be an example of a geographic area over which a base station 105 and a UE 115 may support the communication of signals according to one or more radio access technologies.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the base stations 105, or network equipment (e.g., core network nodes, relay devices, integrated access and backhaul (IAB) nodes, or other network equipment), as shown in FIG. 1.

The base stations 105 may communicate with the core network 130, or with one another, or both. For example, the base stations 105 may interface with the core network 130 through one or more backhaul links 120 (e.g., via an S1, N2, N3, or other interface). The base stations 105 may communicate with one another over the backhaul links 120 (e.g., via an X2, Xn, or other interface) either directly (e.g., directly between base stations 105), or indirectly (e.g., via core network 130), or both. In some examples, the backhaul links 120 may be or include one or more wireless links.

One or more of the base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the base stations 105 and the network equipment including macro eNBs or gNBs, small cell eNBs or gNBs, or relay base stations, among other examples, as shown in FIG. 1.

The UEs 115 and the base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

In some examples (e.g., in a carrier aggregation configuration), a carrier may also have acquisition signaling or control signaling that coordinates operations for other carriers. A carrier may be associated with a frequency channel (e.g., an evolved universal mobile telecommunication system terrestrial radio access (E-UTRA) absolute radio frequency channel number (EARFCN)) and may be positioned according to a channel raster for discovery by the UEs 115. A carrier may be operated in a standalone mode where initial acquisition and connection may be conducted by the UEs 115 via the carrier, or the carrier may be operated in a non-standalone mode where a connection is anchored using a different carrier (e.g., of the same or a different radio access technology).

The communication links 125 shown in the wireless communications system 100 may include uplink transmissions from a UE 115 to a base station 105, or downlink transmissions from a base station 105 to a UE 115. Carriers may carry downlink or uplink communications (e.g., in an FDD mode) or may be configured to carry downlink and uplink communications (e.g., in a TDD mode).

A carrier may be associated with a particular bandwidth of the radio frequency spectrum, and in some examples the carrier bandwidth may be referred to as a “system bandwidth” of the carrier or the wireless communications system 100. For example, the carrier bandwidth may be one of a number of determined bandwidths for carriers of a particular radio access technology (e.g., 1.4, 3, 5, 10, 15, 20, 40, or 80 megahertz (MHz)). Devices of the wireless communications system 100 (e.g., the base stations 105, the UEs 115, or both) may have hardware configurations that support communications over a particular carrier bandwidth or may be configurable to support communications over one of a set of carrier bandwidths. In some examples, the wireless communications system 100 may include base stations 105 or UEs 115 that support simultaneous communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (e.g., spatial layers or beams), and the use of multiple spatial layers may further increase the data rate or data integrity for communications with a UE 115.

One or more numerologies for a carrier may be supported, where a numerology may include a subcarrier spacing (Δƒ) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the base stations 105 or the UEs 115 may be expressed in multiples of a basic time unit which may, for example, refer to a sampling period of Tₛ=1/(Δƒₘₐₓ·N_{ƒ}) seconds, where Δƒₘₐₓ may represent the maximum supported subcarrier spacing, and N_{ƒ} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{ƒ}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., the number of symbol periods in a TTI) may be variable. Additionally or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

Each base station 105 may provide communication coverage via one or more cells, for example a macro cell, a small cell, a hot spot, or other types of cells, or any combination thereof. The term “cell” may refer to a logical communication entity used for communication with a base station 105 (e.g., over a carrier) and may be associated with an identifier for distinguishing neighboring cells (e.g., a physical cell identifier (PCID), a virtual cell identifier (VCID), or others). In some examples, a cell may also refer to a geographic coverage area 110 or a portion of a geographic coverage area 110 (e.g., a sector) over which the logical communication entity operates. Such cells may range from smaller areas (e.g., a structure, a subset of structure) to larger areas depending on various factors such as the capabilities of the base station 105. For example, a cell may be or include a building, a subset of a building, or exterior spaces between or overlapping with geographic coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered base station 105, as compared with a macro cell, and a small cell may operate in the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A base station 105 may support one or multiple cells and may also support communications over the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communications system 100 may include, for example, a heterogeneous network in which different types of the base stations 105 provide coverage for various geographic coverage areas 110 using the same or different radio access technologies.

The wireless communications system 100 may support synchronous or asynchronous operation. For synchronous operation, the base stations 105 may have similar frame timings, and transmissions from different base stations 105 may be approximately aligned in time. For asynchronous operation, the base stations 105 may have different frame timings, and transmissions from different base stations 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a base station 105 without human intervention. In some examples, M2M communication or MTC may include communications from devices that integrate sensors or meters to measure or capture information and relay such information to a central server or application program that makes use of the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception simultaneously). In some examples, half-duplex communications may be performed at a reduced peak rate. Other power conservation techniques for the UEs 115 include entering a power saving deep sleep mode when not engaging in active communications, operating over a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC) or mission critical communications. The UEs 115 may be designed to support ultra-reliable, low-latency, or critical functions (e.g., mission critical functions). Ultra-reliable communications may include private communication or group communication and may be supported by one or more mission critical services such as mission critical push-to-talk (MCPTT), mission critical video (MCVideo), or mission critical data (MCData). Support for mission critical functions may include prioritization of services, and mission critical services may be used for public safety or general commercial applications. The terms ultra-reliable, low-latency, mission critical, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of the UEs 115 communicating via D2D communications may utilize a one-to-many (1:M) system in which each UE 115 transmits to every other UE 115 in the group. In some examples, a base station 105 facilitates the scheduling of resources for D2D communications. In other cases, D2D communications are carried out between the UEs 115 without the involvement of a base station 105.

In some systems, the D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., base stations 105) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the base stations 105 associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices (e.g., radio heads and ANCs) or consolidated into a single network device (e.g., a base station 105).

The wireless communications system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may also operate in a super high frequency (SHF) region using frequency bands from 3 GHz to 30 GHz, also known as the centimeter band, or in an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the base stations 105, and EHF antennas of the respective devices may be smaller and more closely spaced than UHF antennas. In some examples, this may facilitate use of antenna arrays within a device. The propagation of EHF transmissions, however, may be subject to even greater atmospheric attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as the base stations 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally or alternatively, an antenna panel may support radio frequency beamforming for a signal transmitted via an antenna port.

The base stations 105 or the UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry bits associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A base station 105 or a UE 115 may use beam sweeping techniques as part of beam forming operations. For example, a base station 105 may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a base station 105 multiple times in different directions. For example, the base station 105 may transmit a signal according to different beamforming weight sets associated with different directions of transmission. Transmissions in different beam directions may be used to identify (e.g., by a transmitting device, such as a base station 105, or by a receiving device, such as a UE 115) a beam direction for later transmission or reception by the base station 105.

Some signals, such as data signals associated with a particular receiving device, may be transmitted by a base station 105 in a single beam direction (e.g., a direction associated with the receiving device, such as a UE 115). In some examples, the beam direction associated with transmissions along a single beam direction may be determined based on a signal that was transmitted in one or more beam directions. For example, a UE 115 may receive one or more of the signals transmitted by the base station 105 in different directions and may report to the base station 105 an indication of the signal that the UE 115 received with a highest signal quality or an otherwise acceptable signal quality.

In some examples, transmissions by a device (e.g., by a base station 105 or a UE 115) may be performed using multiple beam directions, and the device may use a combination of digital precoding or radio frequency beamforming to generate a combined beam for transmission (e.g., from a base station 105 to a UE 115). The UE 115 may report feedback that indicates precoding weights for one or more beam directions, and the feedback may correspond to a configured number of beams across a system bandwidth or one or more sub-bands. The base station 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted in one or more directions by a base station 105, a UE 115 may employ similar techniques for transmitting signals multiple times in different directions (e.g., for identifying a beam direction for subsequent transmission or reception by the UE 115) or for transmitting a signal in a single direction (e.g., for transmitting data to a receiving device).

A receiving device (e.g., a UE 115) may try multiple receive configurations (e.g., directional listening) when receiving various signals from the base station 105, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned in a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use error detection techniques, error correction techniques, or both to support retransmissions at the MAC layer to improve link efficiency. In the control plane, the Radio Resource Control (RRC) protocol layer may provide establishment, configuration, and maintenance of an RRC connection between a UE 115 and a base station 105 or a core network 130 supporting radio bearers for user plane data. At the physical layer, transport channels may be mapped to physical channels.

The UEs 115 and the base stations 105 may support retransmissions of data to increase the likelihood that data is received successfully. Hybrid automatic repeat request (HARQ) feedback is one technique for increasing the likelihood that data is received correctly over a communication link 125. HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, where the device may provide HARQ feedback in a specific slot for data received in a previous symbol in the slot. In other cases, the device may provide HARQ feedback in a subsequent slot, or according to some other time interval.

In wireless communications system 100, a UE 115 may be a multi-universal subscriber identity module (MUSIM) UE that may be configured with more than one USIM. In some cases, the UE 115 may establish a connection with the network using a first USIM, and the second USIM may be in an idle or inactive mode. In some cases, however, the UE 115 may receive a paging message on the second USIM from a core network 130, which may pause the ongoing communications on the first USIM.

In some cases, the UE 115 may reject the paging on the second USIM in order to resume communications on the first USIM. The UE 115 may reject the paging by sending a busy indication to the network. To reduce latency and inefficiencies associated with processes following the transmission of the busy indication, the wireless communications network 100 may implement a number of techniques. For example, upon receiving a busy indication from the UE 115, the core network may transmit a first non-access stratum (NAS) accept message to the RAN which indicates a second temporary identifier (e.g., a reallocation of a first temporary identifier associated with the paging message) and additional release assistance parameters. In some examples, the release assistance parameters may notify the RAN that it may release its connection with the UE 115 after receiving an uplink NAS message from the UE 115 that acknowledges the reallocation of the first temporary identifier.

The RAN may forward the first NAS accept message to the UE 115 including the second temporary identifier, and the UE 115 may transmit an uplink NAS message to the RAN indicating receipt of the second temporary identifier. Based on receiving the uplink NAS message from the UE 115, and as indicated by the release assistance parameters, the RAN may transmit a release message (e.g., an RRC release message) to the UE 115, and the UE 115 may return to an idle or inactive mode on at least one USIM.

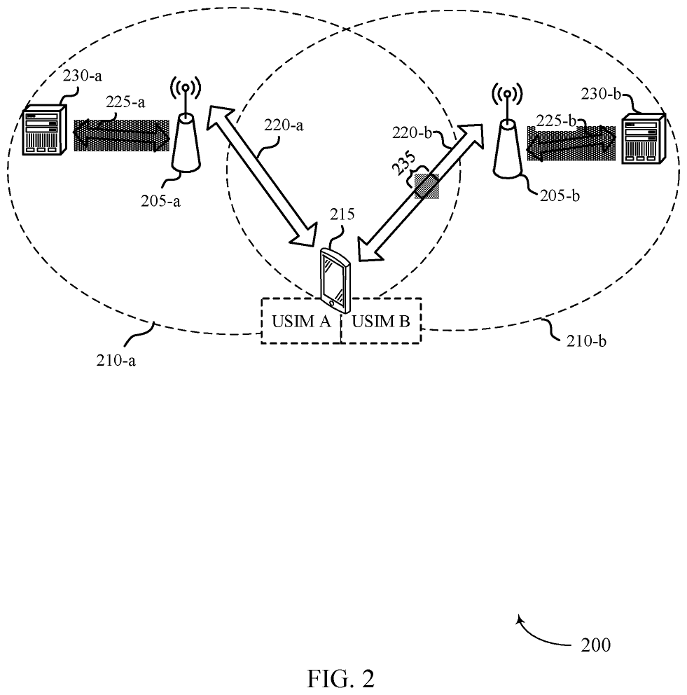

FIG. 2 illustrates an example of a wireless communications system 200 that supports a rapid signaling release solution after paging response in accordance with aspects of the present disclosure. In some examples, wireless communications system 200 may implement aspects of wireless communications system 100. For example, wireless communications system 200 may include a UE 215 and base stations 205 (e.g., base stations 205-a and 205-b) which may be examples of a UE 115 and base stations 105 as described with reference to FIG. 1. In some examples, a base station 205 may be an example of radio access network (RAN) nodes which include both user plane and control plane functionality. In addition, wireless communications system 200 may include core network node 230 (e.g., core network nodes 230-a and 230-b) which may be examples of core network 130 as described with reference to FIG. 1. Additionally or alternatively, core networks 230 may be examples of access and mobility management functions (AMFs), parent inter-access backhaul (IAB) nodes, or other core network controllers.

In some cases, UE 215 may be a subscriber of a network (e.g., wireless communications network 200), and may communicate with a number of other wireless devices and network nodes of wireless communications system 200. In some examples, UE 215 may be equipped with one or more universal subscriber identity modules (USIMs), which may enable secure connection with the network and provide information for network access. A UE 215 equipped with two or more USIMs may be referred to as a multiple USIM (MUSIM) UE 215. For example, MUSIM UE 215 may be equipped with a first USIM (e.g., USIM A) and a second USIM (e.g., USIM B). In some examples, the MUSIM UE 215 may coordinate with the network to pause and continue active communications or an idle mode on at least one of the USIMs for efficient use of network resources.

In wireless communications system 200, MUSIM UE 215 support communications in coverage zone 210-a (e.g., corresponding to base station 205-a) and coverage zone 210-b (e.g., corresponding to base station 205-b). As such, MUSIM UE 215 may be connected (e.g., RRC connected) with both base station 205-a and base station 205-b. In some examples, MUSIM UE 215 may communicate with base station 205-a via communication link 220-a using USIM A and MUSIM UE 215 may communicate with base station 205-b via communication link 220-b using USIM B. In such examples, communication links 220 may be uplink communication links, downlink communication links, or any combination thereof.

Base stations 205 may be connected to the same or different core networks 230. In some cases, for example, in wireless communications system 200, base stations 205 may be connected to separate core networks (e.g., via communication links 225-a and 225-b).

In some cases, the UE 215 may communicate with one or more base stations or core network nodes using the first USIM (e.g., USIM A) and the second USIM (e.g., USIM B). For example, in some cases, a first USIM (e.g., USIM A) of MUSIM UE 215 may be in a connected mode such that MUSIM UE 215 may transmit and receive data to and from base station 205-a via communication link 220-a, and the second USIM (e.g., USIM B) of MUSIM UE 215 may operate in accordance with an idle or inactive mode to conserve battery power of the UE 215.

In some examples, core network 230-b may receive a paging trigger (e.g., an indication of data to send to the MUSIM UE 215, a periodic paging trigger, or other paging message) such that upon receiving the paging trigger, core network 230-b may send a paging message 235 that is associated with a first UE identifier (e.g., a first GUTI) to MUSIM UE 215. For example, core network 230-b may transmit the paging message 235 to base station 205-b, and base station 205-b may transmit the paging message 235 to MUSIM UE 215. Upon receiving the paging message, MUSIM UE 215 may transmit a paging response message (e.g., to accept or reject the paging) to the base station 205-b and the base station 205-b may transmit the paging response message to the core network 230-b.

In some examples, MUSIM UE 215 may participate in ongoing communications on the first USIM (e.g., USIM A), and may receive the paging message 235 on a second USIM (e.g., USIM B). The MUSIM UE 215 may pause communications on the first USIM in order to transition out of idle mode on USIM B to receive the paging message on the second USIM. In some such cases, the MUSIM UE 215 may determine to reject the paging on the second USIM, and may transmit a paging response message to the base station 205-b as a service request non-access stratum (NAS) message including a busy indication (e.g., to reject the paging). In another example, UE 215 may be an example of a single USIM UE 215, and the UE 215 may transition out of the idle or inactive mode to receive the paging message and transmit a paging response message to the base station 205-b.

Transmitting the paging response message may trigger one or more procedures following the paging response message. For example, upon receiving the paging response message including the busy indication, the core network 230 may perform temporary identifier reassignment, configuration updates, connection release, among other procedures, to terminate the paging procedure with the UE 215. Some such procedures, however, may take a long time to complete, thus increasing latency. For example, for cases in which the UE 215 is a MUSIM UE 215, engaging in such procedures following the transmission of the busy indication with the paging response message on a second USIM (e.g., USIM B) may interfere with communications associated with another USIM (e.g., USIM A). For instance, the MUSIM UE 215 may pause communications associated with USIM A in order to complete a busy indication procedure, which may interfere with an activated service for USIM A.

In some examples, the wireless communications system 200 may implement a number of different techniques to increase overall system efficiency and reduce battery consumption and latency associated with a busy indication procedure following the transmission of a paging response. For example, upon receiving a busy indication from the UE 215 on USIM B, the core network 230-b may transmit a first non-access stratum (NAS) accept message to the RAN 205-b which indicates a second UE identifier (e.g., a reallocation of the first UE identifier) and additional release assistance parameters. In some examples, the release assistance parameters may notify the RAN 205-b that it is to release connection with the UE 215 after receiving an uplink NAS message from the UE that indicates an acknowledgement of receipt of the reallocation of the first UE identifier.

The RAN 205-b may relay the first NAS accept message to the UE 215 including the second UE identifier, and the UE 215 may transmit an uplink NAS message to the RAN 205-b indicating receipt of the second UE identifier. Based on receiving the uplink NAS message from the UE 215, and in accordance with the release assistance parameters, the RAN 205-b may transmit a release message (e.g., an RRC release message) to the UE 215 to release the UE 215 from an active communications mode in the USIM B. In such cases, the UE 215 may return to active communications on USIM A and may return to an idle or inactive mode on USIM B. Upon receiving the uplink NAS message from the UE 215, the RAN 205-b may further transmit an additional NAS message to the core network 230-b to indicate successful receipt of the second UE identifier by the UE 215, and the RAN 205-b may initiate release from the core network 230-b.

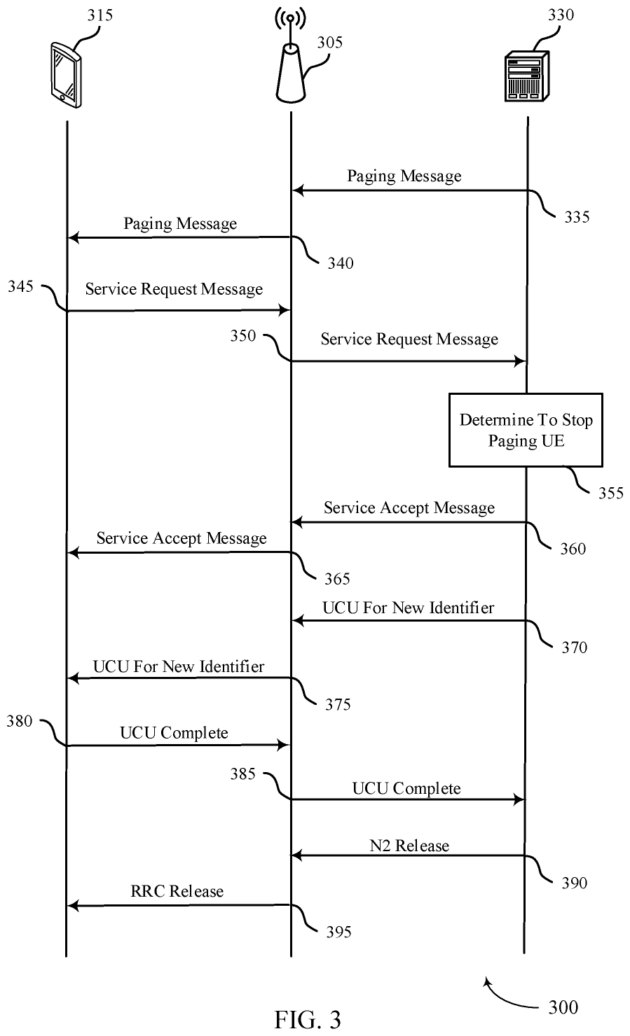

FIG. 3 illustrates an example of a process flow 300 that supports a rapid signaling release solution after paging response in accordance with aspects of the present disclosure. In some examples, process flow 300 may implement aspects of wireless communications system 200 as described with reference to FIG. 2. For example, process flow 300 may include a UE 315 and a base station 305 which may be an example of UE 115 or 215 and a base station 105 or 205 as described with reference to FIGS. 1-2. Additionally, process flow 300 may include core network 330 which may be an example of core network nodes 130 and 230 as described with reference to FIGS. 1-2. While process flow 300 shows communications between a UE 315, a base station 305, and a core network 330, the processes described may apply to any number or combination of network devices described herein. Alternative examples of the following may be implemented, where some steps are performed in a different order than described or are not performed at all. In some cases, steps may include additional features not mentioned below, or further steps may be included.

In some cases, UE 315 may be connected to base station 305 and core network 330. For example, UE 315 may operate in an active mode by establishing an RRC connection with the base station 305, and the base station 305 may communicate with the core network 330 (e.g., via an N1 or N2 interface). In such cases, the UE 315 may be an example of a single USIM UE 315 or a MUSIM UE 315 as described with reference to FIG. 2. In some examples, at least one USIM of UE 315 may be associated with an idle or an inactive mode (e.g., due to a low power mode, or based on communications occurring through a different USIM), while at least one other USIM of the UE 315 may be associated with an active or connected mode. For example, the inactive USIM may remain inactive for a determined inactive time, which may be configured by the network, such that the active USIM may engage in communications.

At 335, core network 330 may transmit a paging message associated with a first UE identifier (e.g., a first GUTI) to base station 305 (e.g., with an end destination of UE 315). In some cases, core network may transmit the paging message to base station 305 in response to a paging trigger (e.g., a paging trigger received from a user plane function (UPF), autonomously determined at the core network 330, or based on one or more data messages indicated for the UE 315).

At 340, base station 305 may transmit or relay the paging message from the core network 330 to UE 315. Upon receiving the paging message, the UE 315 may pause some functions or pause active communications at the UE 315. For example, UE 315 may be an example of a MUSIM UE 315 that may be in an active state for a first USIM (e.g., USIM A), while remaining in an idle mode for a second USIM (e.g., USIM B). The MUSIM UE 315 may keep USIM A in a connected mode during ongoing communications with the network, while USIM B remains idle. In some examples, the UE 315 may receive a paging message associated with USIM B, and thus may transition USIM B to a connected mode (thus pausing communications corresponding to USIM A) to receive the paging message on USIM B. In another example, UE 315 may be a single USIM UE 315 operating in an idle or inactive mode upon receiving the paging message at 340. In such examples, the UE 315 may transition into a connected mode (e.g., the UE 315 may “wake up”) in order to receive the paging message associated with the single USIM. In some cases, the UE 315 may determine to reject the paging message transmitted by the core network 330, for example, when the UE 315 has already received a paging message or in order to remain in an idle state for a longer duration of time than it would if a full paging procedure were to be carried out by the network.

At 345, the UE 315 may transmit, to the base station 305, a service request message (e.g., a paging response message) that is associated with the first UE identifier. In some examples, the UE 315 may include a busy indication (e.g., to reject paging) in or with the service request message. Such service request messages may include, but are not limited to, service request NAS message, control plane service request NAS message, resume messages, mobile terminated (MT) early data transmissions (EDTs), or the like. At 350, the base station 305 may transmit or relay the service request message including the busy indication to the core network 330.

At 355, upon receiving the service request message, the core network 330 may determine to stop paging the UE 315. For example, the core network 330 may determine to stop paging the UE 315 based on determining that the service request message includes the busy indication and is associated with the first UE identifier. In some cases, determining to stop paging the UE may trigger one or more subsequent procedures to release the UE 315 from an RRC connection. An exemplary procedure is described with reference to steps 360 to 395.

At 360, the core network 330 may transmit a service accept message to the base station 305 and, at 365, the base station 305 may transmit the service accept message to the UE 315.

At 370, the core network 330 may reallocate a new UE identifier based on receiving the paging response message with the first UE identifier (e.g., for security purposes). The core network 330 may transmit, to the base station 305, a UE configuration update (UCU) message including a new UE identifier (e.g., to replace the first UE identifier). At 375, the base station 305 may transmit, to the UE 315, the UCU message including the new UE identifier.

At 380, upon receiving the UCU message, the UE 315 may transmit a UCU complete message to base station 305 where, at 385, the base station 305 may transmit or relay the UCU complete message to the core network 330.

At 390, the core network 330 may initiate a connection release (e.g., N2 release) with the base station 305, and at 395, the base station 305 may initiate a connection release (e.g., RRC release) with the UE 315.

In some cases, however, steps described herein (e.g., steps 365 to 395) related to completion of the busy indication procedure may take a significant time to complete. As such, it may be desired to skip some (or all) of the procedure following receiving the paging response message including the paging response message (e.g., such as the service request NAS message transmitted at 345 as described herein). Process flow 300 illustrates one possible procedure following a paging response message. Specifically, process flow 300 describes the method following the UE 315 transmitting, to a core network, a service request message including a busy indication (e.g., to reject paging), and a process by which the core network may reallocate a UE identifier and initiate RRC release based on receiving the paging response.

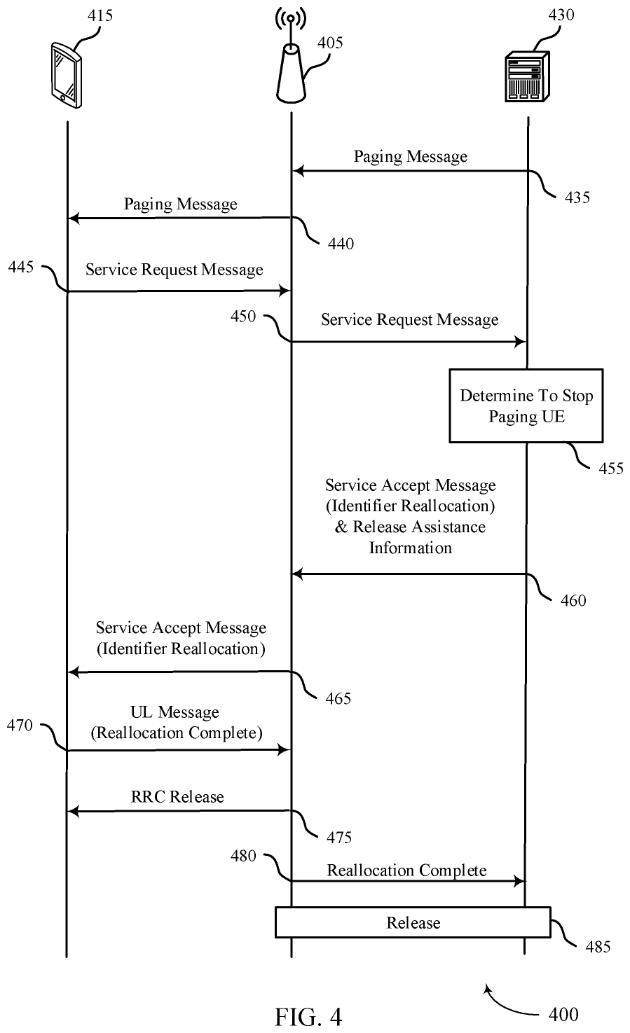

In some examples, to reduce latency and signaling overhead associated with the completion of the busy indication procedure described with reference to process flow 300, the network may implement a number of techniques to reduce excessive signaling or subsequent paging processes. For example, methods described with reference to FIG. 4 support a core network node (such as core network 330) transmitting, to a RAN node 305, a reallocation of the first UE identifier along with release assistance parameters that may instruct the RAN 305 to initiate an early release of the UE 315. For example, the RAN node 305 may relay the reallocated UE identifier to the UE 315, and the UE 315 may transmit an uplink message (e.g., an uplink NAS message) to the RAN 305 which acknowledges the receipt of the reallocated UE identifier. Based on receiving the uplink message from the UE 315 (and in accordance with the release assistance information), the RAN 305 may release the UE 415 (thus effectively skipping steps 370-390 described with reference to FIG. 3). Such methods may decrease battery consumption and communications latency at the UE 315, while decreasing signaling overhead, and enhancing overall system efficiency.

FIG. 4 illustrates an example of a process flow 400 that supports a rapid signaling release solution after paging response in accordance with aspects of the present disclosure. In some examples, process flow 400 may implement aspects of wireless communications systems 100 and 200 as described with reference to FIGS. 1 and 2. For example, process flow 400 may include a UE 415 and a base station 405 which may be examples of a UE 115 or 215 and base stations 105 and 205 as described with reference to FIGS. 1 and 2. Additionally, process flow 400 may include core network 430 which may be an example of core network nodes 130 and 230 as described with reference to FIGS. 1 and 2. While process flow 400 shows communications between a UE 415, a base station 405, and a core network 430, the processes described may apply to any number or combination of network devices described herein. Alternative examples of the following may be implemented, where some steps are performed in a different order than described or are not performed at all. In some cases, steps may include additional features not mentioned below, or further steps may be included.

Upon service establishment, the UE 415 may be connected to base station 405 and core network 430. For instance, UE 415 may establish an RRC connection with the base station 405, and the base station 405 may be connected to core network 430 (e.g., via an N1 or N2 interface). In such a case, the UE 415 may be an example of a single USIM UE 215 or a MUSIM UE 215 as described with reference to FIG. 2. In some examples, at least one USIM of UE 415 may be associated with an idle or an inactive mode (e.g., due to a low power mode enabled for the UE 415, due to communications occurring through a different activated USIM of the UE 415).

At 435, the core network 430 may receive a paging trigger which may trigger the core network 430 to transmit a paging message to the UE 415. The core network 430 may receive the paging trigger from a parent device (e.g., a UPF, a parent IAB node, etc.). The core network 430 may transmit a paging message associated with the first temporary identifier (e.g., a first GUTI) to the base station 405 where, at 440, the base station 405 may transmit or relay the paging message to the UE 415. To receive the paging message, the UE 415 may transition out of an idle or inactive mode. For instance, the UE 415 may be a single USIM UE 415 where the UE 415 may transition out of the idle or inactive mode to receive the paging message (e.g., the UE 415 may “wake up” or transition to an active or connected mode).

Additionally or alternatively, at 440, in examples where the UE 415 is a MUSIM UE, the UE 415 and may pause one or more operations on a second USIM of the UE 415 in order to receive a paging message on a first USIM of the UE 415. For example, the UE 415 may pause operations on the second USIM, and may transition out of an idle state of the first USIM in order to receive the paging message on a first USIM of the UE 415. This paging message may interrupt communications and operations on the second USIM of the UE 415.

At 445, the UE 415 may transmit, to the base station 405, a paging response message associated with the first UE identifier. The paging response message may include, but is not limited to, a service request NAS message, an RRC message, a control plane service request NAS message, a busy indication, a resume message, or any combination thereof. In some examples, the UE 415 may transmit the paging response message in order to reject continued paging by the core network 430.

At 450, the base station 405 may transmit or relay the paging response message with the first temporary identifier to the core network 430. In some cases, the base station 405 may transmit the paging response message as a control plane (e.g., N2) message including the busy indication from the UE 415. At 455, the core network 430 may terminate paging of the UE 415 based on receiving the paging response message.

At 460, the core network 430 may allocate a second temporary identifier (e.g., a second GUTI) which may in some examples be a re-allocation of the first temporary identifier associated with the paging message. The core network 430 may transmit the second temporary identifier in a service accept message (e.g., a service accept NAS message), and the core network 430 may transmit the service accept message via a control plane message or via an N2 interface (e.g., an N2 message). In addition to the service accept message, the core network may transmit a release assistance information message with the service accept message. In some examples, the release assistance information may be a message that is separate from the service accept message, or the release assistance information may be formatted as an information element transmitted with the service accept message. In some cases, the release assistance information may indicate that the RAN 405 may release an RRC connection with the UE 415 after receiving an uplink message (e.g., an uplink NAS message) from the UE 415 which indicates receipt of the reallocation of the first temporary identifier.

At 465, the RAN 405 may transmit or forward, to the UE 415, the service accept message (e.g., the NAS message) including the reallocation of the first temporary identifier.

At 470, the UE 415 may receive the reallocation of the first temporary identifier (e.g., the second temporary identifier) from the RAN 405. To acknowledge receipt of the reallocation, the UE 415 may transmit an uplink message (e.g., an uplink NAS message) to the RAN 405. In some examples, the uplink message may indicate that the reallocation of the first temporary identifier is complete.

At 480, the RAN 405 may receive the uplink message from the UE 415. Based on the release assistance information (e.g., received in step 460), the RAN 405 may determine to release the UE 415 from active connection with the network. For example, the release assistance information may notify the RAN that it is to release the UE 415 after receiving an uplink NAS message transmitted from the UE at 470. The RAN 405 may transmit an RRC release message to the UE 415 to initiate the RRC release.

At 485, the RAN 405 may transmit or forward the uplink message (e.g., the uplink NAS message) from the UE 415 to the core network 430 to indicate the completed re-allocation of the temporary identifier. In some examples, the RAN 405 may transmit forward the uplink message using a control plane message (e.g., an N2 message) to the core network 430. At 475, the RAN 405 may initiate an access network (AN) release of the RAN 405 from the core network 430.

Allowing a RAN 405 to release connection with the UE 415 upon receiving indication of successful temporary identifier re-allocation, may reduce the amount of signaling associated with completion of a busy indication procedure. In addition, such techniques may enable the network to effectively bypass 370-390 described with reference to FIG. 3. Such methods may decrease battery consumption at the UE 415, decrease communications latency at the UE 415, reduce signaling overhead, and enhance system efficiency.

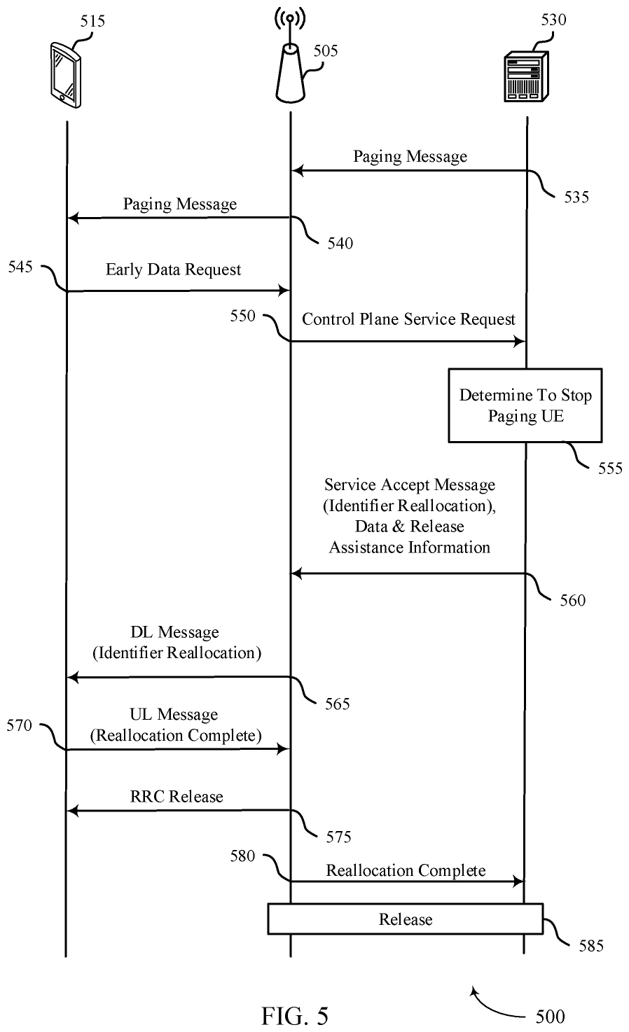

FIG. 5 illustrates an example of a process flow 500 that supports a rapid signaling release solution after paging response in accordance with aspects of the present disclosure. In some examples, process flow 500 may implement aspects of wireless communications systems 100 and 200 as described with reference to FIGS. 1 and 2. For example, process flow 500 may include a UE 515 and a base station 505 which may be examples of a UE 115 or 215 and base stations 105 and 205 as described with reference to FIGS. 1 and 2. Additionally, process flow 500 may include core network 530 which may be an example of core network nodes 130 and 230 as described with reference to FIGS. 1 and 2. While process flow 500 shows communications between a UE 515, a base station 505, and a core network 530, the processes described may apply to any number or combination of network devices described herein. Alternative examples of the following may be implemented, where some steps are performed in a different order than described or are not performed at all. In some cases, steps may include additional features not mentioned below, or further steps may be included.

In some examples, the techniques described herein may be applied to control plane operations. Upon service establishment, the UE 515 may be connected to base station 505 and core network 530. For instance, UE 515 may establish an RRC connection with the base station 505, and the base station 505 may be connected to core network 530 (e.g., via an N1 or N2 interface). In such a case, the UE 515 may be an example of a single USIM UE 215 or a MUSIM UE 215 as described with reference to FIG. 2. In some examples, at least one USIM of UE 515 may be associated with an idle or an inactive mode (e.g., due to a low power mode enabled for the UE 515, due to communications occurring through a different activated USIM of the UE 515).

At 535, the core network 530 may receive a paging trigger which may trigger the core network 530 to transmit a paging message to the UE 515. The core network 530 may receive the paging trigger from a parent device (e.g., a UPF, a parent IAB node, etc.). The core network 530 may transmit a paging message associated with the first temporary identifier (e.g., a first GUTI) to the base station 505 where, at 540, the base station 505 may transmit or relay the paging message to the UE 515. To receive the paging message, the UE 515 may transition out of an idle or inactive mode. For instance, the UE 515 may be a single USIM UE 515 where the UE 515 may transition out of the idle or inactive mode to receive the paging message.

In some other examples the UE 515 may be a MUSIM UE, the UE 515 may pause one or more operations on a second USIM of the UE 515 in order to receive a paging message on a first USIM of the UE 515. For example, the UE 515 may pause operations on the second USIM, and may transition out of an idle state of the first USIM in order to receive the paging message on a first USIM of the UE 515. This paging message may interrupt communications and operations on the second USIM of the UE 515.

At 545, the UE 515 may transmit a paging response message to the base station 505. In some examples, the paging response message may be an RRC early data request message (e.g., to enable the transmission of data during an RRC connection procedure) or a NAS control plane service request (CPSR) message. In some examples, the UE 515 may transmit the paging response message in order to reject continued paging by the core network 530.

At 550, the base station 505 may transmit or relay the paging response message to the core network 530. In some cases, the base station 505 may transmit the paging response message as a control plane message (e.g., N2 initial NAS message including the NAS CPSR) including the busy indication from the UE 515. At 555, the core network 530 may terminate paging of the UE 515 based on receiving the paging response message.

At 560, the core network 530 may allocate a second temporary identifier (e.g., a second GUTI) which may in some examples be a re-allocation of the first temporary identifier associated with the paging message. The core network 530 may transmit the second temporary identifier in a service accept message (e.g., a service accept NAS message), and the core network 530 may transmit the service accept message via a control plane message or via an N2 interface (e.g., an N2 message). In addition to the service accept message, the core network may transmit an additional data packet (e.g., a NAS protocol data unit (PDU)) based on receiving the early data request message from the UE 515. In addition to the service accept message and the data packet, the core network 530 may transmit a release assistance information message with the service accept message. In some examples, the release assistance information may be a message that is separate from the service accept message, or the release assistance information may be formatted as an information element transmitted with the service accept message. In some cases, the release assistance information may indicate that the RAN 505 may release an RRC connection with the UE 515 after receiving an uplink message (e.g., an uplink NAS message) from the UE 515 which indicates receipt of the reallocation of the first temporary identifier.

At 565, the RAN 505 may transmit or forward, the service accept message (e.g., the NAS message) including the reallocation of the first temporary identifier and the additional data packet in a downlink message to the UE 515.

At 570, the UE 515 may receive the reallocation of the first temporary identifier (e.g., the second temporary identifier) from the RAN 505, along with the additional data packet. To acknowledge receipt of the temporary identifier reallocation and data packet, the UE 515 may transmit an uplink message (e.g., an uplink NAS message) to the RAN 505. In some examples, the uplink message may indicate that the reallocation of the first temporary identifier is complete.

At 575, the RAN 505 may receive the uplink message from the UE 515. Based on the release assistance information (e.g., received in step 560), the RAN 505 may determine to release the UE 515 from active connection with the network. For example, the release assistance information may notify the RAN that it is to release the UE 515 after receiving an uplink NAS message transmitted from the UE at 570. The RAN 505 may transmit an RRC release message to the UE 515 to initiate the RRC release.

At 580, the RAN 505 may transmit or forward the uplink message (e.g., the uplink NAS message) from the UE 515 to the core network 530 to indicate the completed re-allocation of the temporary identifier. In some examples, the RAN 505 may transmit forward the uplink message using a control plane message (e.g., an N2 message) to the core network 530. At 575, the RAN 405 may initiate an access network (AN) release of the RAN 505 from the core network 530.

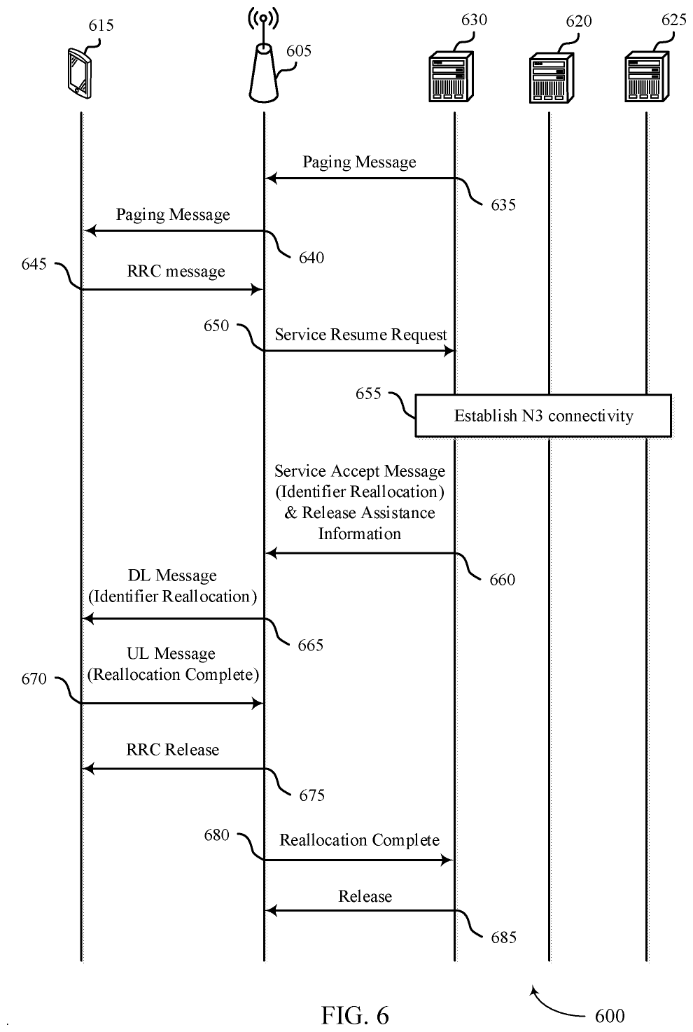

FIG. 6 illustrates an example of a process flow 600 that supports a rapid signaling release solution after paging response in accordance with aspects of the present disclosure. In some examples, process flow 600 may implement aspects of wireless communications systems 100 and 200 as described with reference to FIGS. 1 and 2. For example, process flow 600 may include a UE 615 and a base station 605 which may be examples of a UE 115 or 215 and base stations 105 and 205 as described with reference to FIGS. 1 and 2. Additionally, process flow 600 may include core network 630 which may be an example of core network nodes 130 and 230 as described with reference to FIGS. 1 and 2. In addition, process flow 600 may include a session management function (SMF) 620 which may interact with a decoupled data plane, manage PDU sessions, and manage session context with the user plane function (UPF) 625. While process flow 600 shows communications between a UE 615, a base station 605, a core network 630, an SMF 620, and a UPF 625, the processes described may apply to any number or combination of network devices described herein. Alternative examples of the following may be implemented, where some steps are performed in a different order than described or are not performed at all. In some cases, steps may include additional features not mentioned below, or further steps may be included.

In some examples, the techniques described herein may be applied to user plane operations. Upon service establishment, the UE 615 may be connected to base station 605 and core network 630. For instance, UE 615 may establish an RRC connection with the base station 605, and the base station 605 may be connected to core network 630 (e.g., via an N1 or N2 interface), and with a SMF 620 and a UPF 625 (e.g., via a N3 interface). In such cases, the UE 615 may be an example of a single USIM UE 215 or a MUSIM UE 215 as described with reference to FIG. 2. In some examples, at least one USIM of UE 615 may be associated with an idle or an inactive mode (e.g., due to a low power mode enabled for the UE 615, due to communications occurring through a different activated USIM of the UE 615).

At 635, the core network 630 may receive a paging trigger which may trigger the core network 630 to transmit a mobile terminated early data transmission (MT-EDT) paging message to the UE 615. The core network 630 may receive the paging trigger from a parent device (e.g., a UPF 625, an SMF 620, a parent IAB node, etc.). The core network 630 may transmit a MT-EDT paging message associated with the first temporary identifier (e.g., a first GUTI) to the base station 605 where, at 640, the base station 605 may transmit or relay the MT-EDT paging message to the UE 615. To receive the MT-EDT paging message, the UE 615 may transition out of an idle or inactive mode. For instance, the UE 615 may be a single USIM UE 615 where the UE 615 may transition out of the idle or inactive mode to receive the MT-EDT paging message.

In some other examples the UE 615 may be a MUSIM UE, the UE 615 may pause one or more operations on a second USIM of the UE 615 in order to receive a MT-EDT paging message on a first USIM of the UE 615. For example, the UE 615 may pause operations on the second USIM, and may transition out of an idle state of the first USIM in order to receive the MT-EDT paging message on a first USIM of the UE 615. This paging message may interrupt communications and operations on the second USIM of the UE 615.

At 645, the UE 615 may transmit a paging response message to the base station 605. In some examples, the paging response message may be an RRC early data termination (EDT) message. In some examples, the UE 615 may transmit the paging response message in order to reject continued paging by the core network 630.

At 650, the base station 605 may transmit or relay the paging response message to the core network 630. In some cases, the base station 605 may transmit the paging response message as a control plane message (e.g., N2 initial NAS message) including the busy indication from the UE 515.

At 655, the core network 630 may establish a user plane connection with the SMF 620 and the UPF 625.

At 660, the core network 630 may allocate a second temporary identifier (e.g., a second GUTI) which may in some examples be a re-allocation of the first temporary identifier associated with the paging message. The core network 630 may transmit the second temporary identifier in a service accept message (e.g., a service accept NAS message), and the core network 630 may transmit the service accept message via a control plane message or via an N2 interface (e.g., an N2 message). In addition to the service accept message, the core network may transmit an additional data packet (e.g., a NAS protocol data unit (PDU)) based on receiving the early data request message from the UE 615. In addition to the service accept message and the data packet, the core network 630 may transmit a release assistance information message with the service accept message. In some examples, the release assistance information may be a message that is separate from the service accept message, or the release assistance information may be formatted as an information element transmitted with the service accept message. In some cases, the release assistance information may indicate that the RAN 605 may release an RRC connection with the UE 615 after receiving an uplink message (e.g., an uplink NAS message) from the UE 615 which indicates receipt of the reallocation of the first temporary identifier.

At 665, the RAN 605 may transmit or forward, the service accept message (e.g., the NAS message) including the reallocation of the first temporary identifier and the additional data packet in a downlink message to the UE 615.

At 670, the UE 615 may receive the reallocation of the first temporary identifier (e.g., the second temporary identifier) from the RAN 605, along with the additional data packet. To acknowledge receipt of the temporary identifier reallocation and data packet, the UE 615 may transmit an uplink message (e.g., an uplink NAS message) to the RAN 605. In some examples, the uplink message may indicate that the reallocation of the first temporary identifier is complete.

At 675, the RAN 605 may receive the uplink message from the UE 615. Based on the release assistance information (e.g., received in step 660), the RAN 605 may determine to release the UE 615 from active connection with the network. For example, the release assistance information may notify the RAN that it is to release the UE 615 after receiving an uplink NAS message transmitted from the UE at 670. The RAN 605 may transmit an RRC release message to the UE 615 to initiate the RRC release.

At 680, the RAN 605 may transmit or forward the uplink message (e.g., the uplink NAS message) from the UE 615 to the core network 630 to indicate the completed re-allocation of the temporary identifier. In some examples, the RAN 605 may transmit forward the uplink message using a control plane message (e.g., an N2 message) to the core network 630. At 675, the RAN 605 may initiate an access network (AN) release of the RAN 605 from the core network 630, and may release the user plane session with the SMF 620 and UPF 625.

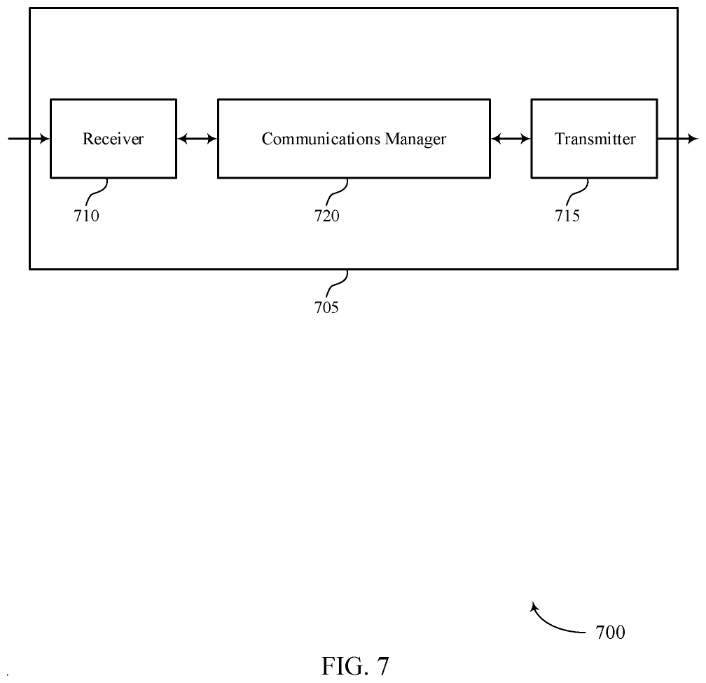

FIG. 7 shows a block diagram 700 of a device 705 that supports a rapid signaling release solution after paging response in accordance with aspects of the present disclosure. The device 705 may be an example of aspects of a UE 115 as described herein. The device 705 may include a receiver 710, a transmitter 715, and a communications manager 720. The device 705 may also include a processor. Each of these components may be in communication with one another (e.g., via one or more buses).

The receiver 710 may provide a means for receiving information such as packets, user data, control information, or any combination thereof associated with various information channels (e.g., control channels, data channels, information channels related to a rapid signaling release solution after paging response). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to a rapid signaling release solution after paging response). In some examples, the transmitter 715 may be co-located with a receiver 710 in a transceiver module. The transmitter 715 may utilize a single antenna or a set of multiple antennas.

The communications manager 720, the receiver 710, the transmitter 715, or various combinations thereof or various components thereof may be examples of means for performing various aspects of a rapid signaling release solution after paging response as described herein. For example, the communications manager 720, the receiver 710, the transmitter 715, or various combinations or components thereof may support a method for performing one or more of the functions described herein.

In some examples, the communications manager 720, the receiver 710, the transmitter 715, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 720, the receiver 710, the transmitter 715, or various combinations or components thereof may be implemented in code (e.g., as communications management software or firmware) executed by a processor. If implemented in code executed by a processor, the functions of the communications manager 720, the receiver 710, the transmitter 715, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some examples, the communications manager 720 may be configured to perform various operations (e.g., receiving, monitoring, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to receive information, transmit information, or perform various other operations as described herein.

The communications manager 720 may support wireless communications at a UE in accordance with examples as disclosed herein. For example, the communications manager 720 may be configured as or otherwise support a means for transmitting, to a radio access network node, a first control message indicating a request to terminate a paging procedure at the UE, the first control message associated with a first temporary identifier for the UE. The communications manager 720 may be configured as or otherwise support a means for receiving, from the radio access network node, a first non-access stratum message including both an acknowledgement of the request to terminate the paging procedure in response to the first control message and an indication of a reallocation of the first temporary identifier for the UE. The communications manager 720 may be configured as or otherwise support a means for transmitting, to the radio access network node and in response to the first non-access stratum message, a second non-access stratum message indicating receipt of the reallocation of the first temporary identifier. The communications manager 720 may be configured as or otherwise support a means for receiving, from the radio access network node, a second control message indicating a service release of the UE from the radio access network node in response to the second non-access stratum message.

By including or configuring the communications manager 720 in accordance with examples as described herein, the device 705 (e.g., a processor controlling or otherwise coupled to the receiver 710, the transmitter 715, the communications manager 720, or a combination thereof) may support techniques for reduced processing, reduced power consumption, more efficient utilization of communication resources, and reduced signaling overhead.

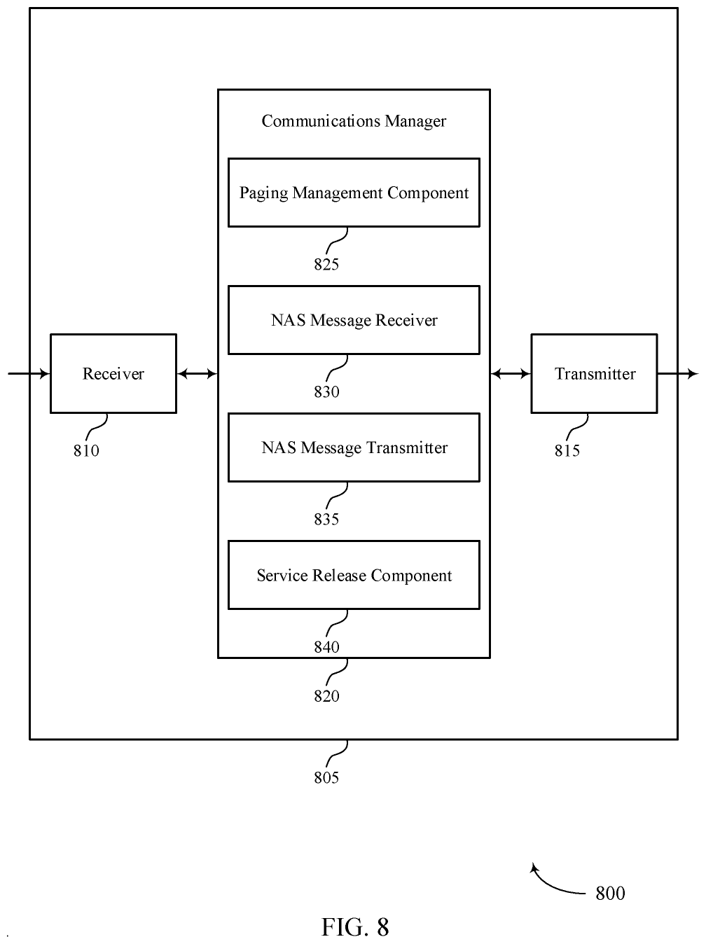

FIG. 8 shows a block diagram 800 of a device 805 that supports a rapid signaling release solution after paging response in accordance with aspects of the present disclosure. The device 805 may be an example of aspects of a device 705 or a UE 115 as described herein. The device 805 may include a receiver 810, a transmitter 815, and a communications manager 820. The device 805 may also include a processor. Each of these components may be in communication with one another (e.g., via one or more buses).

The receiver 810 may provide a means for receiving information such as packets, user data, control information, or any combination thereof associated with various information channels (e.g., control channels, data channels, information channels related to a rapid signaling release solution after paging response). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to a rapid signaling release solution after paging response). In some examples, the transmitter 815 may be co-located with a receiver 810 in a transceiver module. The transmitter 815 may utilize a single antenna or a set of multiple antennas.

The device 805, or various components thereof, may be an example of means for performing various aspects of a rapid signaling release solution after paging response as described herein. For example, the communications manager 820 may include a paging management component 825, a NAS message receiver 830, a NAS message transmitter 835, a service release component 840, or any combination thereof. The communications manager 820 may be an example of aspects of a communications manager 720 as described herein. In some examples, the communications manager 820, or various components thereof, may be configured to perform various operations (e.g., receiving, monitoring, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to receive information, transmit information, or perform various other operations as described herein.

The communications manager 820 may support wireless communications at a UE in accordance with examples as disclosed herein. The paging management component 825 may be configured as or otherwise support a means for transmitting, to a radio access network node, a first control message indicating a request to terminate a paging procedure at the UE, the first control message associated with a first temporary identifier for the UE. The NAS message receiver 830 may be configured as or otherwise support a means for receiving, from the radio access network node, a first non-access stratum message including both an acknowledgement of the request to terminate the paging procedure in response to the first control message and an indication of a reallocation of the first temporary identifier for the UE. The NAS message transmitter 835 may be configured as or otherwise support a means for transmitting, to the radio access network node and in response to the first non-access stratum message, a second non-access stratum message indicating receipt of the reallocation of the first temporary identifier. The service release component 840 may be configured as or otherwise support a means for receiving, from the radio access network node, a second control message indicating a service release of the UE from the radio access network node in response to the second non-access stratum message.

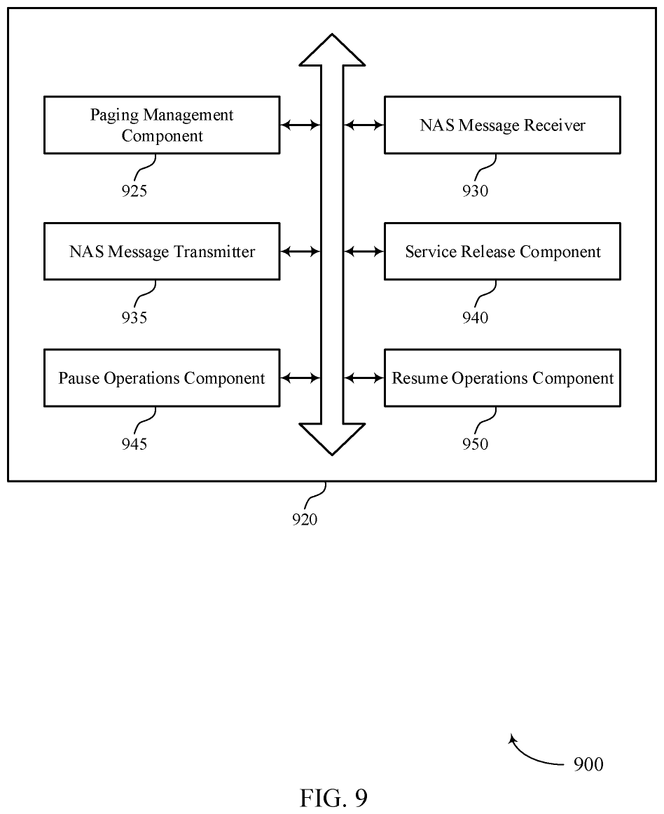

FIG. 9 shows a block diagram 900 of a communications manager 920 that supports a rapid signaling release solution after paging response in accordance with aspects of the present disclosure. The communications manager 920 may be an example of aspects of a communications manager 720, a communications manager 820, or both, as described herein. The communications manager 920, or various components thereof, may be an example of means for performing various aspects of a rapid signaling release solution after paging response as described herein. For example, the communications manager 920 may include a paging management component 925, a NAS message receiver 930, a NAS message transmitter 935, a service release component 940, a pause operations component 945, a resume operations component 950, or any combination thereof. Each of these components may communicate, directly or indirectly, with one another (e.g., via one or more buses).

The communications manager 920 may support wireless communications at a UE in accordance with examples as disclosed herein. The paging management component 925 may be configured as or otherwise support a means for transmitting, to a radio access network node, a first control message indicating a request to terminate a paging procedure at the UE, the first control message associated with a first temporary identifier for the UE. The NAS message receiver 930 may be configured as or otherwise support a means for receiving, from the radio access network node, a first non-access stratum message including both an acknowledgement of the request to terminate the paging procedure in response to the first control message and an indication of a reallocation of the first temporary identifier for the UE. The NAS message transmitter 935 may be configured as or otherwise support a means for transmitting, to the radio access network node and in response to the first non-access stratum message, a second non-access stratum message indicating receipt of the reallocation of the first temporary identifier. The service release component 940 may be configured as or otherwise support a means for receiving, from the radio access network node, a second control message indicating a service release of the UE from the radio access network node in response to the second non-access stratum message.

In some examples, the service release component 940 may be configured as or otherwise support a means for initiating the service release of the UE from the radio access network node upon receiving the second control message.

In some examples, the first non-access stratum message further includes at least one data packet for the UE, and the NAS message transmitter 935 may be configured as or otherwise support a means for transmitting, to the radio access network node, the second non-access stratum message indicating receipt of the first non-access stratum message.

In some examples, the at least one data packet includes a non-access stratum packet data unit. In some examples, the first non-access stratum message includes a downlink control message. In some examples, the first control message includes a non-access stratum service request message or a non-access stratum control plane service request message.

In some examples, the pause operations component 945 may be configured as or otherwise support a means for pausing one or more operations of the UE in accordance with transmitting the first control message. In some examples, the resume operations component 950 may be configured as or otherwise support a means for resuming the one or more operations of the UE upon transmitting the second non-access stratum message indicating receipt of the reallocation of the first temporary identifier.

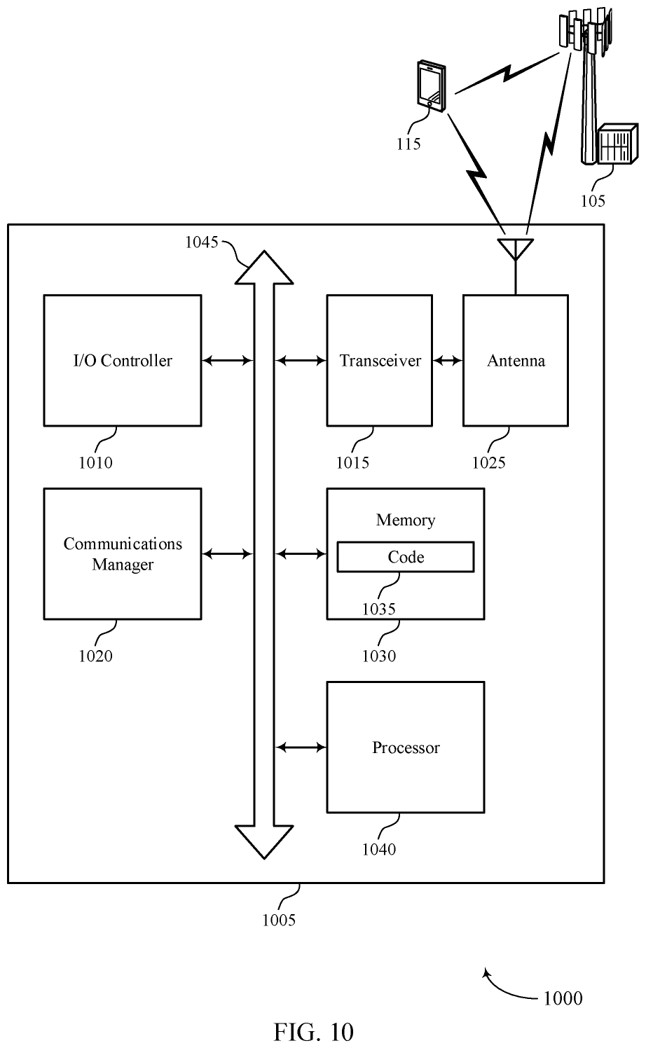

FIG. 10 shows a diagram of a system 1000 including a device 1005 that supports a rapid signaling release solution after paging response in accordance with aspects of the present disclosure. The device 1005 may be an example of or include the components of a device 705, a device 805, or a UE 115 as described herein. The device 1005 may communicate wirelessly with one or more base stations 105, UEs 115, or any combination thereof. The device 1005 may include components for bi-directional voice and data communications including components for transmitting and receiving communications, such as a communications manager 1020, an input/output (I/O) controller 1010, a transceiver 1015, an antenna 1025, a memory 1030, code 1035, and a processor 1040. These components may be in electronic communication or otherwise coupled (e.g., operatively, communicatively, functionally, electronically, electrically) via one or more buses (e.g., a bus 1045).

The I/O controller 1010 may manage input and output signals for the device 1005. The I/O controller 1010 may also manage peripherals not integrated into the device 1005. In some cases, the I/O controller 1010 may represent a physical connection or port to an external peripheral. In some cases, the I/O controller 1010 may utilize an operating system such as iOS®, ANDROID®, MS-DOS®, MS-WINDOWS®, OS/2®, UNIX®, LINUX®, or another known operating system. Additionally or alternatively, the I/O controller 1010 may represent or interact with a modem, a keyboard, a mouse, a touchscreen, or a similar device. In some cases, the I/O controller 1010 may be implemented as part of a processor, such as the processor 1040. In some cases, a user may interact with the device 1005 via the I/O controller 1010 or via hardware components controlled by the I/O controller 1010.

In some cases, the device 1005 may include a single antenna 1025. However, in some other cases, the device 1005 may have more than one antenna 1025, which may be capable of concurrently transmitting or receiving multiple wireless transmissions. The transceiver 1015 may communicate bi-directionally, via the one or more antennas 1025, wired, or wireless links as described herein. For example, the transceiver 1015 may represent a wireless transceiver and may communicate bi-directionally with another wireless transceiver. The transceiver 1015 may also include a modem to modulate the packets, to provide the modulated packets to one or more antennas 1025 for transmission, and to demodulate packets received from the one or more antennas 1025. The transceiver 1015, or the transceiver 1015 and one or more antennas 1025, may be an example of a transmitter 715, a transmitter 815, a receiver 710, a receiver 810, or any combination thereof or component thereof, as described herein.

The memory 1030 may include random access memory (RAM) and read-only memory (ROM). The memory 1030 may store computer-readable, computer-executable code 1035 including instructions that, when executed by the processor 1040, cause the device 1005 to perform various functions described herein. The code 1035 may be stored in a non-transitory computer-readable medium such as system memory or another type of memory. In some cases, the code 1035 may not be directly executable by the processor 1040 but may cause a computer (e.g., when compiled and executed) to perform functions described herein. In some cases, the memory 1030 may contain, among other things, a basic I/O system (BIOS) which may control basic hardware or software operation such as the interaction with peripheral components or devices.

The processor 1040 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1040 may be configured to operate a memory array using a memory controller. In some other cases, a memory controller may be integrated into the processor 1040. The processor 1040 may be configured to execute computer-readable instructions stored in a memory (e.g., the memory 1030) to cause the device 1005 to perform various functions (e.g., functions or tasks supporting a rapid signaling release solution after paging response). For example, the device 1005 or a component of the device 1005 may include a processor 1040 and memory 1030 coupled to the processor 1040, the processor 1040 and memory 1030 configured to perform various functions described herein.

The communications manager 1020 may support wireless communications at a UE in accordance with examples as disclosed herein. For example, the communications manager 1020 may be configured as or otherwise support a means for transmitting, to a radio access network node, a first control message indicating a request to terminate a paging procedure at the UE, the first control message associated with a first temporary identifier for the UE. The communications manager 1020 may be configured as or otherwise support a means for receiving, from the radio access network node, a first non-access stratum message including both an acknowledgement of the request to terminate the paging procedure in response to the first control message and an indication of a reallocation of the first temporary identifier for the UE. The communications manager 1020 may be configured as or otherwise support a means for transmitting, to the radio access network node and in response to the first non-access stratum message, a second non-access stratum message indicating receipt of the reallocation of the first temporary identifier. The communications manager 1020 may be configured as or otherwise support a means for receiving, from the radio access network node, a second control message indicating a service release of the UE from the radio access network node in response to the second non-access stratum message.

By including or configuring the communications manager 1020 in accordance with examples as described herein, the device 1005 may support techniques for improved communication reliability, reduced latency associated with reduced time between transmitting a busy indication (associated with a paging procedure) and resuming a connected mode or idle mode, improved user experience related to such reduced latency, reduced power consumption, more efficient utilization of communication resources, and longer battery life.

In some examples, the communications manager 1020 may be configured to perform various operations (e.g., receiving, monitoring, transmitting) using or otherwise in cooperation with the transceiver 1015, the one or more antennas 1025, or any combination thereof. Although the communications manager 1020 is illustrated as a separate component, in some examples, one or more functions described with reference to the communications manager 1020 may be supported by or performed by the processor 1040, the memory 1030, the code 1035, or any combination thereof. For example, the code 1035 may include instructions executable by the processor 1040 to cause the device 1005 to perform various aspects of a rapid signaling release solution after paging response as described herein, or the processor 1040 and the memory 1030 may be otherwise configured to perform or support such operations.

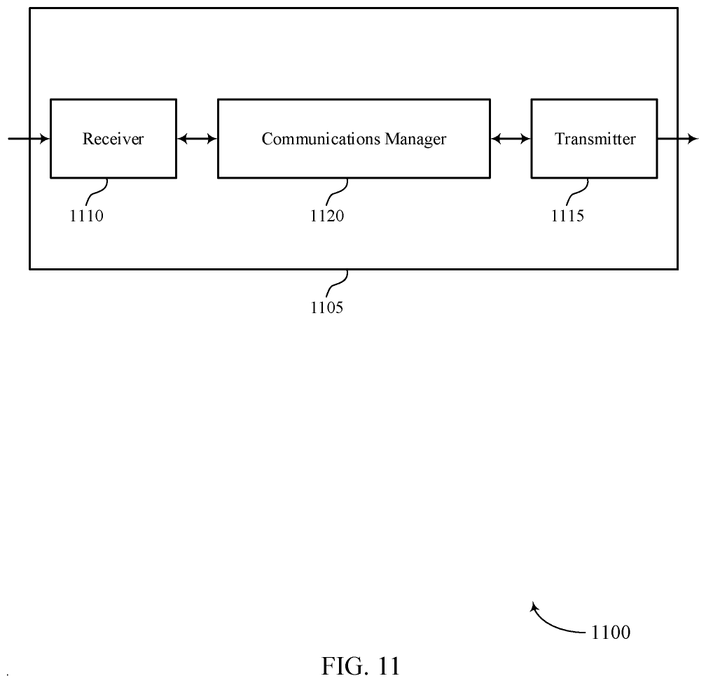

FIG. 11 shows a block diagram 1100 of a device 1105 that supports a rapid signaling release solution after paging response in accordance with aspects of the present disclosure. The device 1105 may be an example of aspects of a base station 105 as described herein. The device 1105 may include a receiver 1110, a transmitter 1115, and a communications manager 1120. The device 1105 may also include a processor. Each of these components may be in communication with one another (e.g., via one or more buses).

The receiver 1110 may provide a means for receiving information such as packets, user data, control information, or any combination thereof associated with various information channels (e.g., control channels, data channels, information channels related to a rapid signaling release solution after paging response). Information may be passed on to other components of the device 1105. The receiver 1110 may utilize a single antenna or a set of multiple antennas.

The transmitter 1115 may provide a means for transmitting signals generated by other components of the device 1105. For example, the transmitter 1115 may transmit information such as packets, user data, control information, or any combination thereof associated with various information channels (e.g., control channels, data channels, information channels related to a rapid signaling release solution after paging response). In some examples, the transmitter 1115 may be co-located with a receiver 1110 in a transceiver module. The transmitter 1115 may utilize a single antenna or a set of multiple antennas.

The communications manager 1120, the receiver 1110, the transmitter 1115, or various combinations thereof or various components thereof may be examples of means for performing various aspects of a rapid signaling release solution after paging response as described herein. For example, the communications manager 1120, the receiver 1110, the transmitter 1115, or various combinations or components thereof may support a method for performing one or more of the functions described herein.

In some examples, the communications manager 1120, the receiver 1110, the transmitter 1115, or various combinations or components thereof may be implemented in hardware (e.g., in communications management circuitry). The hardware may include a processor, a DSP, an ASIC, an FPGA or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 1120, the receiver 1110, the transmitter 1115, or various combinations or components thereof may be implemented in code (e.g., as communications management software or firmware) executed by a processor. If implemented in code executed by a processor, the functions of the communications manager 1120, the receiver 1110, the transmitter 1115, or various combinations or components thereof may be performed by a general-purpose processor, a DSP, a CPU, an ASIC, an FPGA, or any combination of these or other programmable logic devices (e.g., configured as or otherwise supporting a means for performing the functions described in the present disclosure).

In some examples, the communications manager 1120 may be configured to perform various operations (e.g., receiving, monitoring, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to receive information, transmit information, or perform various other operations as described herein.

The communications manager 1120 may support wireless communications at a radio access network node in accordance with examples as disclosed herein. For example, the communications manager 1120 may be configured as or otherwise support a means for transmitting, to a core network node, a first control message from a UE indicating a request to terminate a paging procedure at the UE, the first control message associated with a first temporary identifier for the UE. The communications manager 1120 may be configured as or otherwise support a means for receiving, from the core network node, a first non-access stratum message including a first portion and a second portion, the first portion including both an acknowledgement of the request to terminate the paging procedure in response to the first control message and an indication of a reallocation of the first temporary identifier, the second portion including a set of release assistance parameters associated with triggering a service release of the UE from the radio access network node. The communications manager 1120 may be configured as or otherwise support a means for relaying, to the UE, the first portion of the first non-access stratum message. The communications manager 1120 may be configured as or otherwise support a means for receiving, from the UE, a second non-access stratum message in response to the first non-access stratum message indicating receipt of the reallocation of the first temporary identifier. The communications manager 1120 may be configured as or otherwise support a means for transmitting, to the UE, a second control message indicating the service release of the UE from the radio access network node in accordance with the set of release assistance parameters and in response to receiving the second non-access stratum message.

Additionally or alternatively, the communications manager 1120 may support wireless communications at a core network node in accordance with examples as disclosed herein. For example, the communications manager 1120 may be configured as or otherwise support a means for receiving, from a radio access network node, a first control message from a UE indicating a request to terminate a paging procedure at the UE, the first control message associated with a first temporary identifier for the UE. The communications manager 1120 may be configured as or otherwise support a means for transmitting, to the radio access network node, a first non-access stratum message including a first portion and a second portion, the first portion including both an acknowledgement of the request to terminate the paging procedure in response to the first control message and an indication of a reallocation of the first temporary identifier, the second portion including a set of release assistance parameters associated with triggering a service release of the UE from the radio access network node. The communications manager 1120 may be configured as or otherwise support a means for receiving, from the radio access network node, a second non-access stratum message indicating the service release of the UE from the radio access network node in accordance with the set of release assistance parameters and in response to receiving the reallocation of the first temporary identifier.

By including or configuring the communications manager 1120 in accordance with examples as described herein, the device 1105 (e.g., a processor controlling or otherwise coupled to the receiver 1110, the transmitter 1115, the communications manager 1120, or a combination thereof) may support techniques for reduced processing, reduced power consumption, more efficient utilization of communication resources, and reduced signaling overhead.

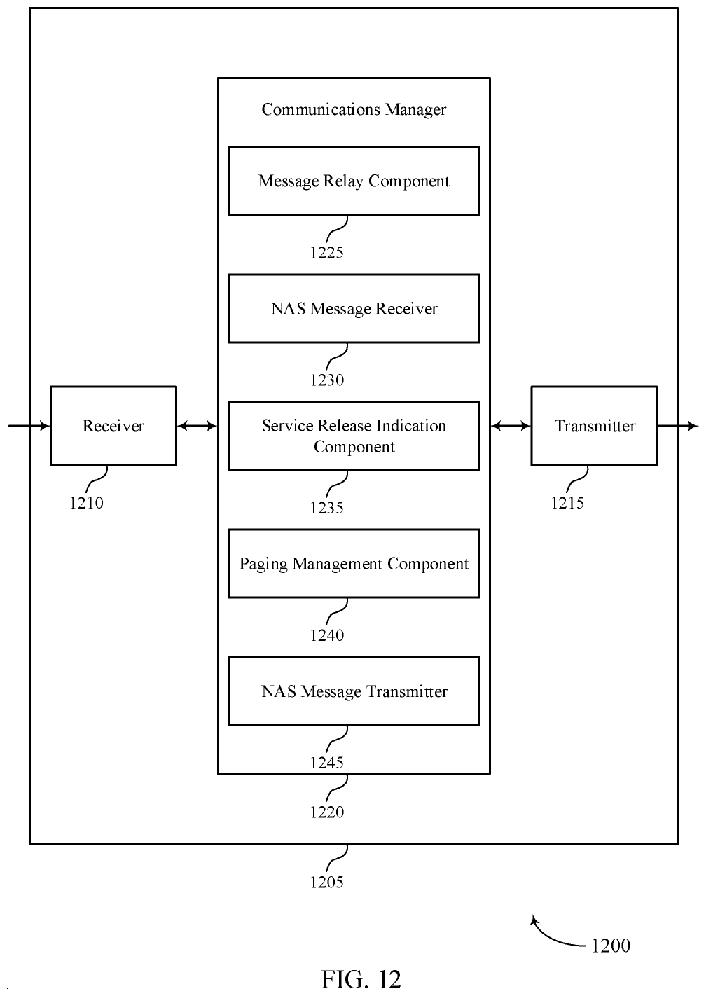

FIG. 12 shows a block diagram 1200 of a device 1205 that supports a rapid signaling release solution after paging response in accordance with aspects of the present disclosure. The device 1205 may be an example of aspects of a device 1105 or a base station 105 as described herein. The device 1205 may include a receiver 1210, a transmitter 1215, and a communications manager 1220. The device 1205 may also include a processor. Each of these components may be in communication with one another (e.g., via one or more buses).

The receiver 1210 may provide a means for receiving information such as packets, user data, control information, or any combination thereof associated with various information channels (e.g., control channels, data channels, information channels related to a rapid signaling release solution after paging response). Information may be passed on to other components of the device 1205. The receiver 1210 may utilize a single antenna or a set of multiple antennas.

The transmitter 1215 may provide a means for transmitting signals generated by other components of the device 1205. For example, the transmitter 1215 may transmit information such as packets, user data, control information, or any combination thereof associated with various information channels (e.g., control channels, data channels, information channels related to a rapid signaling release solution after paging response). In some examples, the transmitter 1215 may be co-located with a receiver 1210 in a transceiver module. The transmitter 1215 may utilize a single antenna or a set of multiple antennas.

The device 1205, or various components thereof, may be an example of means for performing various aspects of a rapid signaling release solution after paging response as described herein. For example, the communications manager 1220 may include a message relay component 1225, a NAS message receiver 1230, a service release indication component 1235, a paging management component 1240, a NAS message transmitter 1245, or any combination thereof. The communications manager 1220 may be an example of aspects of a communications manager 1120 as described herein. In some examples, the communications manager 1220, or various components thereof, may be configured to perform various operations (e.g., receiving, monitoring, transmitting) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to receive information, transmit information, or perform various other operations as described herein.

The communications manager 1220 may support wireless communications at a radio access network node in accordance with examples as disclosed herein. The message relay component 1225 may be configured as or otherwise support a means for transmitting, to a core network node, a first control message from a UE indicating a request to terminate a paging procedure at the UE, the first control message associated with a first temporary identifier for the UE. The NAS message receiver 1230 may be configured as or otherwise support a means for receiving, from the core network node, a first non-access stratum message including a first portion and a second portion, the first portion including both an acknowledgement of the request to terminate the paging procedure in response to the first control message and an indication of a reallocation of the first temporary identifier, the second portion including a set of release assistance parameters associated with triggering a service release of the UE from the radio access network node. The message relay component 1225 may be configured as or otherwise support a means for relaying, to the UE, the first portion of the first non-access stratum message. The NAS message receiver 1230 may be configured as or otherwise support a means for receiving, from the UE, a second non-access stratum message in response to the first non-access stratum message indicating receipt of the reallocation of the first temporary identifier. The service release indication component 1235 may be configured as or otherwise support a means for transmitting, to the UE, a second control message indicating the service release of the UE from the radio access network node in accordance with the set of release assistance parameters and in response to receiving the second non-access stratum message.

Additionally or alternatively, the communications manager 1220 may support wireless communications at a core network node in accordance with examples as disclosed herein. The paging management component 1240 may be configured as or otherwise support a means for receiving, from a radio access network node, a first control message from a UE indicating a request to terminate a paging procedure at the UE, the first control message associated with a first temporary identifier for the UE. The NAS message transmitter 1245 may be configured as or otherwise support a means for transmitting, to the radio access network node, a first non-access stratum message including a first portion and a second portion, the first portion including both an acknowledgement of the request to terminate the paging procedure in response to the first control message and an indication of a reallocation of the first temporary identifier, the second portion including a set of release assistance parameters associated with triggering a service release of the UE from the radio access network node. The NAS message receiver 1230 may be configured as or otherwise support a means for receiving, from the radio access network node, a second non-access stratum message indicating the service release of the UE from the radio access network node in accordance with the set of release assistance parameters and in response to receiving the reallocation of the first temporary identifier.

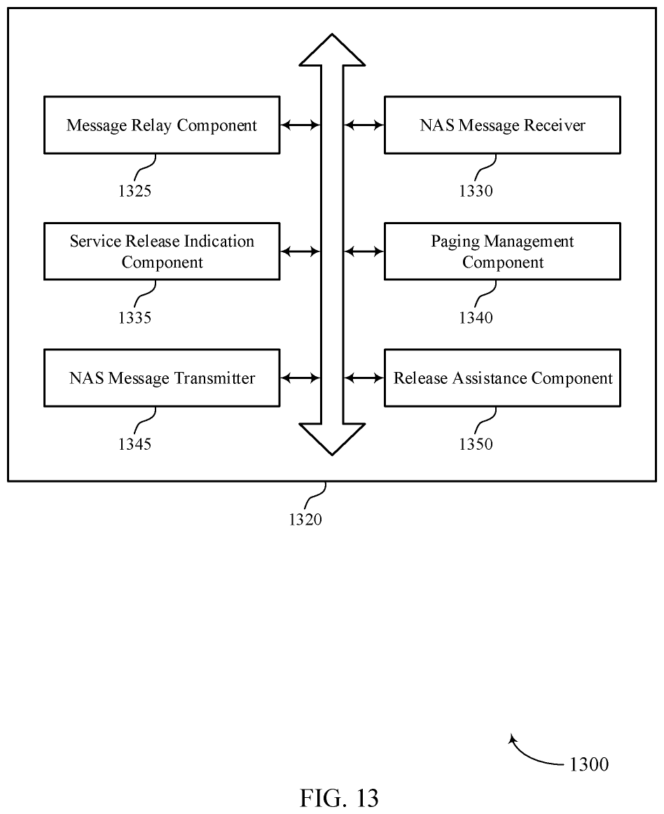

FIG. 13 shows a block diagram 1300 of a communications manager 1320 that supports a rapid signaling release solution after paging response in accordance with aspects of the present disclosure. The communications manager 1320 may be an example of aspects of a communications manager 1120, a communications manager 1220, or both, as described herein. The communications manager 1320, or various components thereof, may be an example of means for performing various aspects of a rapid signaling release solution after paging response as described herein. For example, the communications manager 1320 may include a message relay component 1325, a NAS message receiver 1330, a service release indication component 1335, a paging management component 1340, a NAS message transmitter 1345, a release assistance component 1350, or any combination thereof. Each of these components may communicate, directly or indirectly, with one another (e.g., via one or more buses).

The communications manager 1320 may support wireless communications at a radio access network node in accordance with examples as disclosed herein. The message relay component 1325 may be configured as or otherwise support a means for transmitting, to a core network node, a first control message from a UE indicating a request to terminate a paging procedure at the UE, the first control message associated with a first temporary identifier for the UE. The NAS message receiver 1330 may be configured as or otherwise support a means for receiving, from the core network node, a first non-access stratum message including a first portion and a second portion, the first portion including both an acknowledgement of the request to terminate the paging procedure in response to the first control message and an indication of a reallocation of the first temporary identifier, the second portion including a set of release assistance parameters associated with triggering a service release of the UE from the radio access network node. In some examples, the message relay component 1325 may be configured as or otherwise support a means for relaying, to the UE, the first portion of the first non-access stratum message. In some examples, the NAS message receiver 1330 may be configured as or otherwise support a means for receiving, from the UE, a second non-access stratum message in response to the first non-access stratum message indicating receipt of the reallocation of the first temporary identifier. The service release indication component 1335 may be configured as or otherwise support a means for transmitting, to the UE, a second control message indicating the service release of the UE from the radio access network node in accordance with the set of release assistance parameters and in response to receiving the second non-access stratum message.

In some examples, the release assistance component 1350 may be configured as or otherwise support a means for determining, from the set of release assistance parameters, that the radio access network node is to initiate the service release of the UE based on receiving the second non-access stratum message.

In some examples, the NAS message transmitter 1345 may be configured as or otherwise support a means for transmitting, to the core network node, a third non-access stratum message indicating receipt of the reallocation of the first temporary identifier at the UE and indicating the service release of the UE from the radio access network node.

In some examples, the first non-access stratum message is an N2 message from the core network node including the reallocation of the first temporary identifier and the set of release assistance parameters.

In some examples, the first non-access stratum message includes at least one data packet for the UE, and the NAS message receiver 1330 may be configured as or otherwise support a means for receiving, from the UE, the second non-access stratum message indicating receipt of the first non-access stratum message. In some examples, the first non-access stratum message includes a downlink control message.

Additionally or alternatively, the communications manager 1320 may support wireless communications at a core network node in accordance with examples as disclosed herein. The paging management component 1340 may be configured as or otherwise support a means for receiving, from a radio access network node, a first control message from a UE indicating a request to terminate a paging procedure at the UE, the first control message associated with a first temporary identifier for the UE. The NAS message transmitter 1345 may be configured as or otherwise support a means for transmitting, to the radio access network node, a first non-access stratum message including a first portion and a second portion, the first portion including both an acknowledgement of the request to terminate the paging procedure in response to the first control message and an indication of a reallocation of the first temporary identifier, the second portion including a set of release assistance parameters associated with triggering a service release of the UE from the radio access network node. In some examples, the NAS message receiver 1330 may be configured as or otherwise support a means for receiving, from the radio access network node, a second non-access stratum message indicating the service release of the UE from the radio access network node in accordance with the set of release assistance parameters and in response to receiving the reallocation of the first temporary identifier.

In some examples, the set of release assistance parameters indicate that the radio access network node is to initiate the service release of the UE based on receiving the second non-access stratum message from the UE. In some examples, the first non-access stratum message is an N2 message including the reallocation of the first temporary identifier and the set of release assistance parameters. In some examples, the first non-access stratum message including the reallocation of the first temporary identifier includes at least one data packet for the UE.

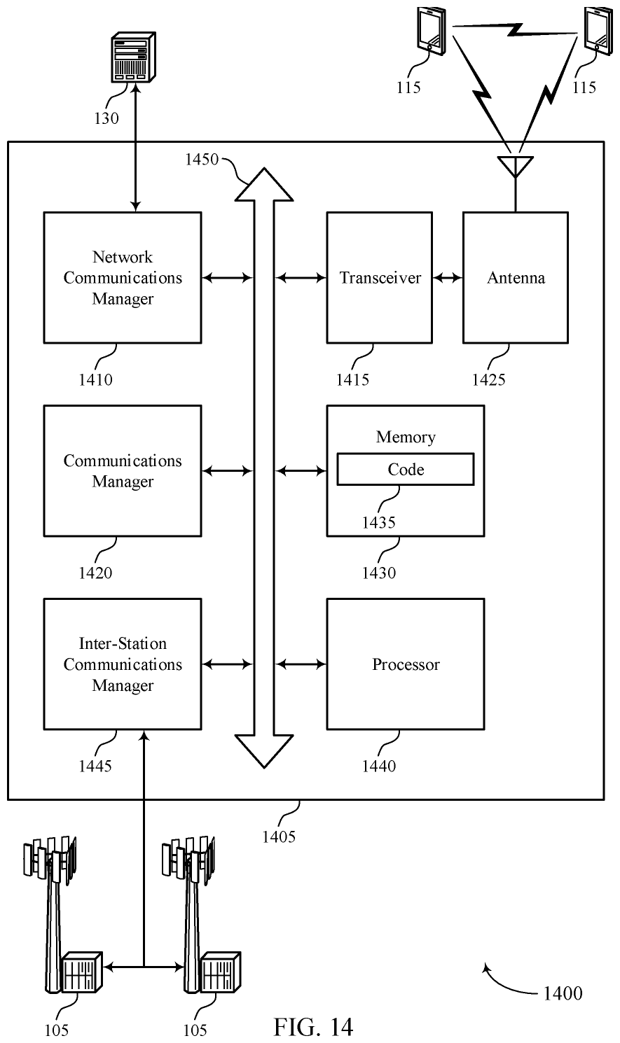

FIG. 14 shows a diagram of a system 1400 including a device 1405 that supports a rapid signaling release solution after paging response in accordance with aspects of the present disclosure. The device 1405 may be an example of or include the components of a device 1105, a device 1205, or a base station 105 as described herein. The device 1405 may communicate wirelessly with one or more base stations 105, UEs 115, or any combination thereof. The device 1405 may include components for bi-directional voice and data communications including components for transmitting and receiving communications, such as a communications manager 1420, a network communications manager 1410, a transceiver 1415, an antenna 1425, a memory 1430, code 1435, a processor 1440, and an inter-station communications manager 1445. These components may be in electronic communication or otherwise coupled (e.g., operatively, communicatively, functionally, electronically, electrically) via one or more buses (e.g., a bus 1450).

The network communications manager 1410 may manage communications with a core network 130 (e.g., via one or more wired backhaul links). For example, the network communications manager 1410 may manage the transfer of data communications for client devices, such as one or more UEs 115.

In some cases, the device 1405 may include a single antenna 1425. However, in some other cases the device 1405 may have more than one antenna 1425, which may be capable of concurrently transmitting or receiving multiple wireless transmissions. The transceiver 1415 may communicate bi-directionally, via the one or more antennas 1425, wired, or wireless links as described herein. For example, the transceiver 1415 may represent a wireless transceiver and may communicate bi-directionally with another wireless transceiver. The transceiver 1415 may also include a modem to modulate the packets, to provide the modulated packets to one or more antennas 1425 for transmission, and to demodulate packets received from the one or more antennas 1425. The transceiver 1415, or the transceiver 1415 and one or more antennas 1425, may be an example of a transmitter 1115, a transmitter 1215, a receiver 1110, a receiver 1210, or any combination thereof or component thereof, as described herein.

The memory 1430 may include RAM and ROM. The memory 1430 may store computer-readable, computer-executable code 1435 including instructions that, when executed by the processor 1440, cause the device 1405 to perform various functions described herein. The code 1435 may be stored in a non-transitory computer-readable medium such as system memory or another type of memory. In some cases, the code 1435 may not be directly executable by the processor 1440 but may cause a computer (e.g., when compiled and executed) to perform functions described herein. In some cases, the memory 1430 may contain, among other things, a BIOS which may control basic hardware or software operation such as the interaction with peripheral components or devices.

The processor 1440 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1440 may be configured to operate a memory array using a memory controller. In some other cases, a memory controller may be integrated into the processor 1440. The processor 1440 may be configured to execute computer-readable instructions stored in a memory (e.g., the memory 1430) to cause the device 1405 to perform various functions (e.g., functions or tasks supporting a rapid signaling release solution after paging response). For example, the device 1405 or a component of the device 1405 may include a processor 1440 and memory 1430 coupled to the processor 1440, the processor 1440 and memory 1430 configured to perform various functions described herein.

The inter-station communications manager 1445 may manage communications with other base stations 105, and may include a controller or scheduler for controlling communications with UEs 115 in cooperation with other base stations 105. For example, the inter-station communications manager 1445 may coordinate scheduling for transmissions to UEs 115 for various interference mitigation techniques such as beamforming or joint transmission. In some examples, the inter-station communications manager 1445 may provide an X2 interface within an LTE/LTE-A wireless communications network technology to provide communication between base stations 105.

The communications manager 1420 may support wireless communications at a radio access network node in accordance with examples as disclosed herein. For example, the communications manager 1420 may be configured as or otherwise support a means for transmitting, to a core network node, a first control message from a UE indicating a request to terminate a paging procedure at the UE, the first control message associated with a first temporary identifier for the UE. The communications manager 1420 may be configured as or otherwise support a means for receiving, from the core network node, a first non-access stratum message including a first portion and a second portion, the first portion including both an acknowledgement of the request to terminate the paging procedure in response to the first control message and an indication of a reallocation of the first temporary identifier, the second portion including a set of release assistance parameters associated with triggering a service release of the UE from the radio access network node. The communications manager 1420 may be configured as or otherwise support a means for relaying, to the UE, the first portion of the first non-access stratum message. The communications manager 1420 may be configured as or otherwise support a means for receiving, from the UE, a second non-access stratum message in response to the first non-access stratum message indicating receipt of the reallocation of the first temporary identifier. The communications manager 1420 may be configured as or otherwise support a means for transmitting, to the UE, a second control message indicating the service release of the UE from the radio access network node in accordance with the set of release assistance parameters and in response to receiving the second non-access stratum message.

Additionally or alternatively, the communications manager 1420 may support wireless communications at a core network node in accordance with examples as disclosed herein. For example, the communications manager 1420 may be configured as or otherwise support a means for receiving, from a radio access network node, a first control message from a UE indicating a request to terminate a paging procedure at the UE, the first control message associated with a first temporary identifier for the UE. The communications manager 1420 may be configured as or otherwise support a means for transmitting, to the radio access network node, a first non-access stratum message including a first portion and a second portion, the first portion including both an acknowledgement of the request to terminate the paging procedure in response to the first control message and an indication of a reallocation of the first temporary identifier, the second portion including a set of release assistance parameters associated with triggering a service release of the UE from the radio access network node. The communications manager 1420 may be configured as or otherwise support a means for receiving, from the radio access network node, a second non-access stratum message indicating the service release of the UE from the radio access network node in accordance with the set of release assistance parameters and in response to receiving the reallocation of the first temporary identifier.

By including or configuring the communications manager 1420 in accordance with examples as described herein, the device 1405 may support techniques for improved communication reliability, reduced latency associated with reduced time between transmitting a busy indication (associated with a paging procedure) and resuming a connected mode or idle mode, improved user experience related to such reduced latency, reduced power consumption, more efficient utilization of communication resources, and longer battery life.

In some examples, the communications manager 1420 may be configured to perform various operations (e.g., receiving, monitoring, transmitting) using or otherwise in cooperation with the transceiver 1415, the one or more antennas 1425, or any combination thereof. Although the communications manager 1420 is illustrated as a separate component, in some examples, one or more functions described with reference to the communications manager 1420 may be supported by or performed by the processor 1440, the memory 1430, the code 1435, or any combination thereof. For example, the code 1435 may include instructions executable by the processor 1440 to cause the device 1405 to perform various aspects of a rapid signaling release solution after paging response as described herein, or the processor 1440 and the memory 1430 may be otherwise configured to perform or support such operations.

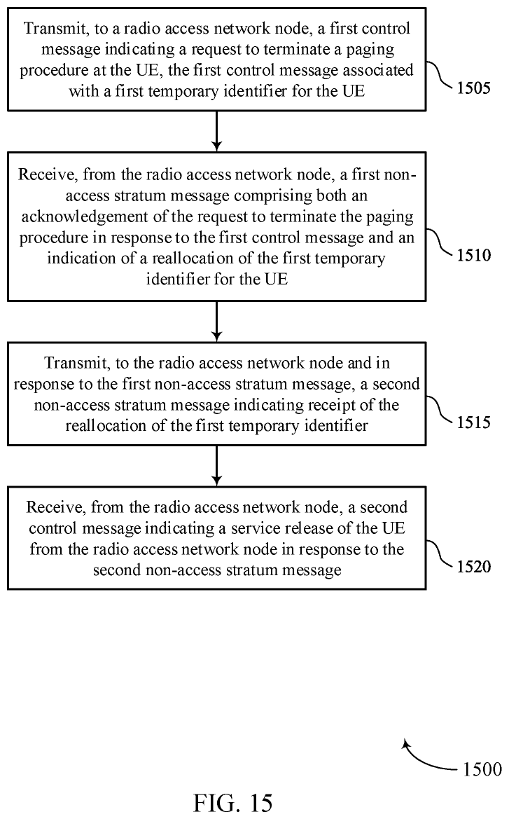

FIG. 15 shows a flowchart illustrating a method 1500 that supports a rapid signaling release solution after paging response in accordance with aspects of the present disclosure. The operations of the method 1500 may be implemented by a UE or its components as described herein. For example, the operations of the method 1500 may be performed by a UE 115 as described with reference to FIGS. 1 through 10. In some examples, a UE may execute a set of instructions to control the functional elements of the UE to perform the described functions. Additionally or alternatively, the UE may perform aspects of the described functions using special-purpose hardware.

At 1505, the method may include transmitting, to a radio access network node, a first control message indicating a request to terminate a paging procedure at the UE, the first control message associated with a first temporary identifier for the UE. The operations of 1505 may be performed in accordance with examples as disclosed herein. In some examples, aspects of the operations of 1505 may be performed by a paging management component 925 as described with reference to FIG. 9.

At 1510, the method may include receiving, from the radio access network node, a first non-access stratum message including both an acknowledgement of the request to terminate the paging procedure in response to the first control message and an indication of a reallocation of the first temporary identifier for the UE. The operations of 1510 may be performed in accordance with examples as disclosed herein. In some examples, aspects of the operations of 1510 may be performed by a NAS message receiver 930 as described with reference to FIG. 9.

At 1515, the method may include transmitting, to the radio access network node and in response to the first non-access stratum message, a second non-access stratum message indicating receipt of the reallocation of the first temporary identifier. The operations of 1515 may be performed in accordance with examples as disclosed herein. In some examples, aspects of the operations of 1515 may be performed by a NAS message transmitter 935 as described with reference to FIG. 9.

At 1520, the method may include receiving, from the radio access network node, a second control message indicating a service release of the UE from the radio access network node in response to the second non-access stratum message. The operations of 1520 may be performed in accordance with examples as disclosed herein. In some examples, aspects of the operations of 1520 may be performed by a service release component 940 as described with reference to FIG. 9.

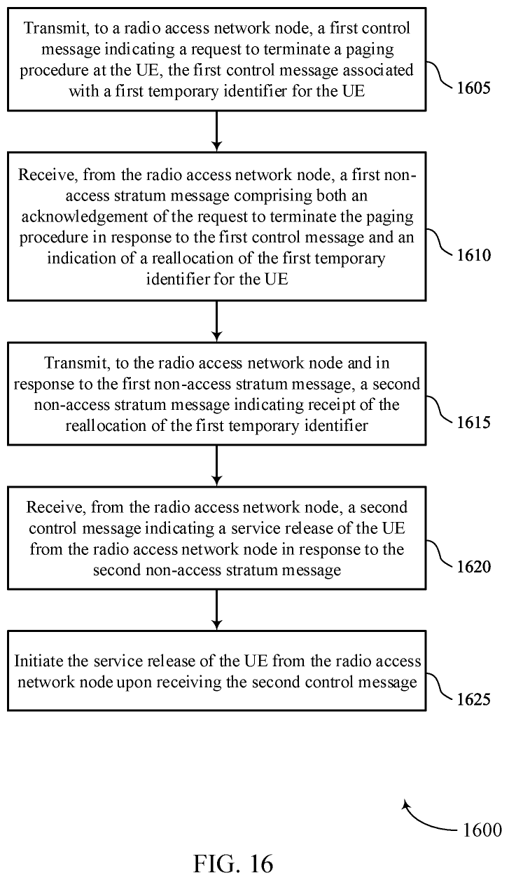

FIG. 16 shows a flowchart illustrating a method 1600 that supports a rapid signaling release solution after paging response in accordance with aspects of the present disclosure. The operations of the method 1600 may be implemented by a UE or its components as described herein. For example, the operations of the method 1600 may be performed by a UE 115 as described with reference to FIGS. 1 through 10. In some examples, a UE may execute a set of instructions to control the functional elements of the UE to perform the described functions. Additionally or alternatively, the UE may perform aspects of the described functions using special-purpose hardware.

At 1605, the method may include transmitting, to a radio access network node, a first control message indicating a request to terminate a paging procedure at the UE, the first control message associated with a first temporary identifier for the UE. The operations of 1605 may be performed in accordance with examples as disclosed herein. In some examples, aspects of the operations of 1605 may be performed by a paging management component 925 as described with reference to FIG. 9.

At 1610, the method may include receiving, from the radio access network node, a first non-access stratum message including both an acknowledgement of the request to terminate the paging procedure in response to the first control message and an indication of a reallocation of the first temporary identifier for the UE. The operations of 1610 may be performed in accordance with examples as disclosed herein. In some examples, aspects of the operations of 1610 may be performed by a NAS message receiver 930 as described with reference to FIG. 9.

At 1615, the method may include transmitting, to the radio access network node and in response to the first non-access stratum message, a second non-access stratum message indicating receipt of the reallocation of the first temporary identifier. The operations of 1615 may be performed in accordance with examples as disclosed herein. In some examples, aspects of the operations of 1615 may be performed by a NAS message transmitter 935 as described with reference to FIG. 9.

At 1620, the method may include receiving, from the radio access network node, a second control message indicating a service release of the UE from the radio access network node in response to the second non-access stratum message. The operations of 1620 may be performed in accordance with examples as disclosed herein. In some examples, aspects of the operations of 1620 may be performed by a service release component 940 as described with reference to FIG. 9.

At 1625, the method may include initiating the service release of the UE from the radio access network node upon receiving the second control message. The operations of 1625 may be performed in accordance with examples as disclosed herein. In some examples, aspects of the operations of 1625 may be performed by a service release component 940 as described with reference to FIG. 9.

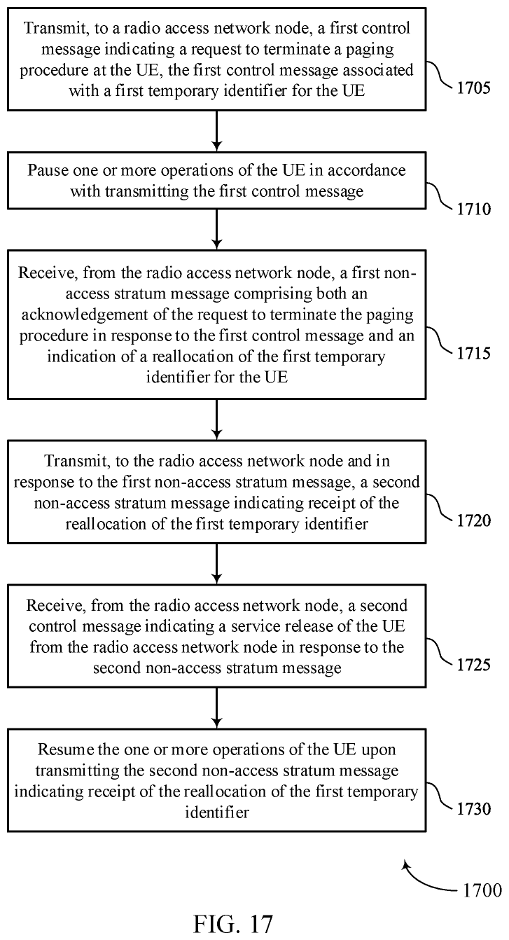

FIG. 17 shows a flowchart illustrating a method 1700 that supports a rapid signaling release solution after paging response in accordance with aspects of the present disclosure. The operations of the method 1700 may be implemented by a UE or its components as described herein. For example, the operations of the method 1700 may be performed by a UE 115 as described with reference to FIGS. 1 through 10. In some examples, a UE may execute a set of instructions to control the functional elements of the UE to perform the described functions. Additionally or alternatively, the UE may perform aspects of the described functions using special-purpose hardware.

At 1705, the method may include transmitting, to a radio access network node, a first control message indicating a request to terminate a paging procedure at the UE, the first control message associated with a first temporary identifier for the UE. The operations of 1705 may be performed in accordance with examples as disclosed herein. In some examples, aspects of the operations of 1705 may be performed by a paging management component 925 as described with reference to FIG. 9.

At 1710, the method may include pausing one or more operations of the UE in accordance with transmitting the first control message. The operations of 1710 may be performed in accordance with examples as disclosed herein. In some examples, aspects of the operations of 1710 may be performed by a pause operations component 945 as described with reference to FIG. 9.

At 1715, the method may include receiving, from the radio access network node, a first non-access stratum message including both an acknowledgement of the request to terminate the paging procedure in response to the first control message and an indication of a reallocation of the first temporary identifier for the UE. The operations of 1715 may be performed in accordance with examples as disclosed herein. In some examples, aspects of the operations of 1715 may be performed by a NAS message receiver 930 as described with reference to FIG. 9.

At 1720, the method may include transmitting, to the radio access network node and in response to the first non-access stratum message, a second non-access stratum message indicating receipt of the reallocation of the first temporary identifier. The operations of 1720 may be performed in accordance with examples as disclosed herein. In some examples, aspects of the operations of 1720 may be performed by a NAS message transmitter 935 as described with reference to FIG. 9.

At 1725, the method may include receiving, from the radio access network node, a second control message indicating a service release of the UE from the radio access network node in response to the second non-access stratum message. The operations of 1725 may be performed in accordance with examples as disclosed herein. In some examples, aspects of the operations of 1725 may be performed by a service release component 940 as described with reference to FIG. 9.

At 1730, the method may include resuming the one or more operations of the UE upon transmitting the second non-access stratum message indicating receipt of the reallocation of the first temporary identifier. The operations of 1730 may be performed in accordance with examples as disclosed herein. In some examples, aspects of the operations of 1730 may be performed by a resume operations component 950 as described with reference to FIG. 9.

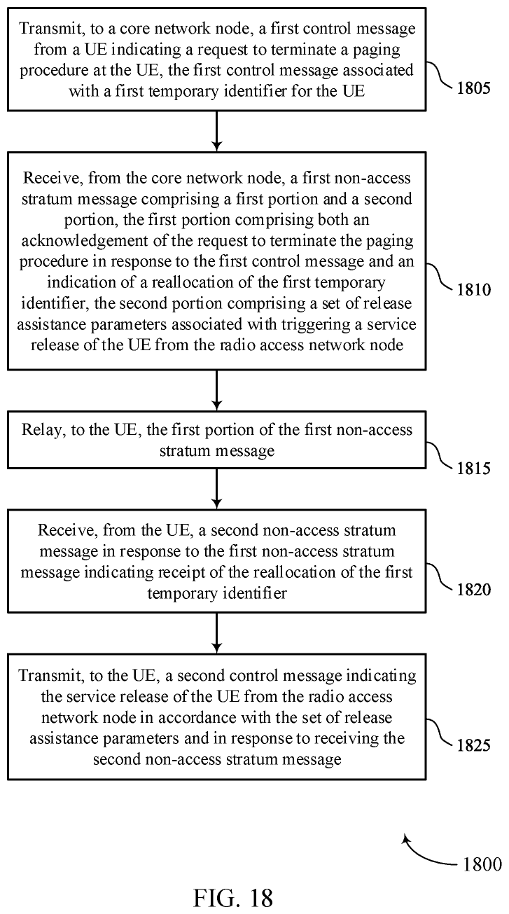

FIG. 18 shows a flowchart illustrating a method 1800 that supports a rapid signaling release solution after paging response in accordance with aspects of the present disclosure. The operations of the method 1800 may be implemented by a base station or its components as described herein. For example, the operations of the method 1800 may be performed by a base station 105 as described with reference to FIGS. 1 through 6 and 11 through 14. In some examples, a base station may execute a set of instructions to control the functional elements of the base station to perform the described functions. Additionally or alternatively, the base station may perform aspects of the described functions using special-purpose hardware.

At 1805, the method may include transmitting, to a core network node, a first control message from a UE indicating a request to terminate a paging procedure at the UE, the first control message associated with a first temporary identifier for the UE. The operations of 1805 may be performed in accordance with examples as disclosed herein. In some examples, aspects of the operations of 1805 may be performed by a message relay component 1325 as described with reference to FIG. 13.

At 1810, the method may include receiving, from the core network node, a first non-access stratum message including a first portion and a second portion, the first portion including both an acknowledgement of the request to terminate the paging procedure in response to the first control message and an indication of a reallocation of the first temporary identifier, the second portion including a set of release assistance parameters associated with triggering a service release of the UE from the radio access network node. The operations of 1810 may be performed in accordance with examples as disclosed herein. In some examples, aspects of the operations of 1810 may be performed by a NAS message receiver 1330 as described with reference to FIG. 13.

At 1815, the method may include relaying, to the UE, the first portion of the first non-access stratum message. The operations of 1815 may be performed in accordance with examples as disclosed herein. In some examples, aspects of the operations of 1815 may be performed by a message relay component 1325 as described with reference to FIG. 13.

At 1820, the method may include receiving, from the UE, a second non-access stratum message in response to the first non-access stratum message indicating receipt of the reallocation of the first temporary identifier. The operations of 1820 may be performed in accordance with examples as disclosed herein. In some examples, aspects of the operations of 1820 may be performed by a NAS message receiver 1330 as described with reference to FIG. 13.

At 1825, the method may include transmitting, to the UE, a second control message indicating the service release of the UE from the radio access network node in accordance with the set of release assistance parameters and in response to receiving the second non-access stratum message. The operations of 1825 may be performed in accordance with examples as disclosed herein. In some examples, aspects of the operations of 1825 may be performed by a service release indication component 1335 as described with reference to FIG. 13.

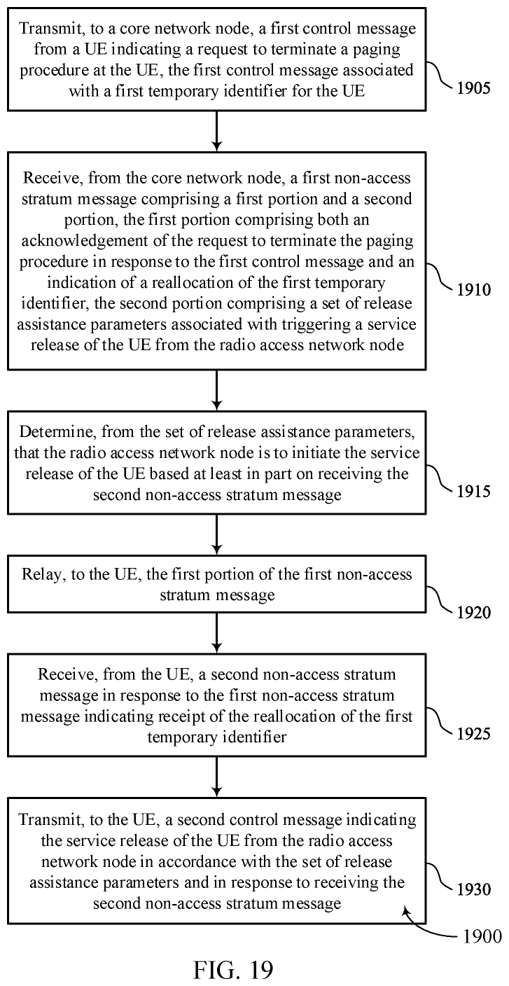

FIG. 19 shows a flowchart illustrating a method 1900 that supports a rapid signaling release solution after paging response in accordance with aspects of the present disclosure. The operations of the method 1900 may be implemented by a base station or its components as described herein. For example, the operations of the method 1900 may be performed by a base station 105 as described with reference to FIGS. 1 through 6 and 11 through 14. In some examples, a base station may execute a set of instructions to control the functional elements of the base station to perform the described functions. Additionally or alternatively, the base station may perform aspects of the described functions using special-purpose hardware.

At 1905, the method may include transmitting, to a core network node, a first control message from a UE indicating a request to terminate a paging procedure at the UE, the first control message associated with a first temporary identifier for the UE. The operations of 1905 may be performed in accordance with examples as disclosed herein. In some examples, aspects of the operations of 1905 may be performed by a message relay component 1325 as described with reference to FIG. 13.

At 1910, the method may include receiving, from the core network node, a first non-access stratum message including a first portion and a second portion, the first portion including both an acknowledgement of the request to terminate the paging procedure in response to the first control message and an indication of a reallocation of the first temporary identifier, the second portion including a set of release assistance parameters associated with triggering a service release of the UE from the radio access network node. The operations of 1910 may be performed in accordance with examples as disclosed herein. In some examples, aspects of the operations of 1910 may be performed by a NAS message receiver 1330 as described with reference to FIG. 13.

At 1915, the method may include determining, from the set of release assistance parameters, that the radio access network node is to initiate the service release of the UE based on receiving the second non-access stratum message. The operations of 1915 may be performed in accordance with examples as disclosed herein. In some examples, aspects of the operations of 1915 may be performed by a release assistance component 1350 as described with reference to FIG. 13.

At 1920, the method may include relaying, to the UE, the first portion of the first non-access stratum message. The operations of 1920 may be performed in accordance with examples as disclosed herein. In some examples, aspects of the operations of 1920 may be performed by a message relay component 1325 as described with reference to FIG. 13.

At 1925, the method may include receiving, from the UE, a second non-access stratum message in response to the first non-access stratum message indicating receipt of the reallocation of the first temporary identifier. The operations of 1925 may be performed in accordance with examples as disclosed herein. In some examples, aspects of the operations of 1925 may be performed by a NAS message receiver 1330 as described with reference to FIG. 13.

At 1930, the method may include transmitting, to the UE, a second control message indicating the service release of the UE from the radio access network node in accordance with the set of release assistance parameters and in response to receiving the second non-access stratum message. The operations of 1930 may be performed in accordance with examples as disclosed herein. In some examples, aspects of the operations of 1930 may be performed by a service release indication component 1335 as described with reference to FIG. 13.

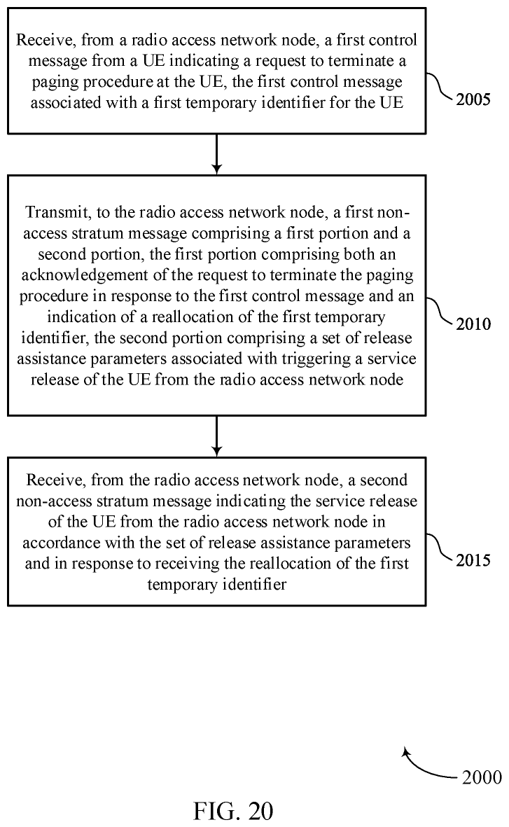

FIG. 20 shows a flowchart illustrating a method 2000 that supports a rapid signaling release solution after paging response in accordance with aspects of the present disclosure. The operations of the method 2000 may be implemented by a base station or its components as described herein. For example, the operations of the method 2000 may be performed by a base station 105 as described with reference to FIGS. 1 through 6 and 11 through 14. In some examples, a base station may execute a set of instructions to control the functional elements of the base station to perform the described functions. Additionally or alternatively, the base station may perform aspects of the described functions using special-purpose hardware.

At 2005, the method may include receiving, from a radio access network node, a first control message from a UE indicating a request to terminate a paging procedure at the UE, the first control message associated with a first temporary identifier for the UE. The operations of 2005 may be performed in accordance with examples as disclosed herein. In some examples, aspects of the operations of 2005 may be performed by a paging management component 1340 as described with reference to FIG. 13.

At 2010, the method may include transmitting, to the radio access network node, a first non-access stratum message including a first portion and a second portion, the first portion including both an acknowledgement of the request to terminate the paging procedure in response to the first control message and an indication of a reallocation of the first temporary identifier, the second portion including a set of release assistance parameters associated with triggering a service release of the UE from the radio access network node. The operations of 2010 may be performed in accordance with examples as disclosed herein. In some examples, aspects of the operations of 2010 may be performed by a NAS message transmitter 1345 as described with reference to FIG. 13.

At 2015, the method may include receiving, from the radio access network node, a second non-access stratum message indicating the service release of the UE from the radio access network node in accordance with the set of release assistance parameters and in response to receiving the reallocation of the first temporary identifier. The operations of 2015 may be performed in accordance with examples as disclosed herein. In some examples, aspects of the operations of 2015 may be performed by a NAS message receiver 1330 as described with reference to FIG. 13.

### SUMMARY OF ASPECTS

The following provides an overview of aspects of the present disclosure:

Aspect 1: A method for wireless communications at a UE, comprising: transmitting, to a radio access network node, a first control message indicating a request to terminate a paging procedure at the UE, the first control message associated with a first temporary identifier for the UE; receiving, from the radio access network node, a first non-access stratum message comprising both an acknowledgement of the request to terminate the paging procedure in response to the first control message and an indication of a reallocation of the first temporary identifier for the UE; transmitting, to the radio access network node and in response to the first non-access stratum message, a second non-access stratum message indicating receipt of the reallocation of the first temporary identifier; and receiving, from the radio access network node, a second control message indicating a service release of the UE from the radio access network node in response to the second non-access stratum message.

Aspect 2: The method of aspect 1, further comprising: initiating the service release of the UE from the radio access network node upon receiving the second control message.

Aspect 3: The method of any of aspects 1 through 2, wherein the first non-access stratum message further comprises at least one data packet for the UE, the method further comprising: transmitting, to the radio access network node, the second non-access stratum message indicating receipt of the first non-access stratum message.

Aspect 4: The method of aspect 3, wherein the at least one data packet comprises a non-access stratum packet data unit.

Aspect 5: The method of any of aspects 1 through 4, wherein the first non-access stratum message comprises a downlink control message.

Aspect 6: The method of any of aspects 1 through 5, wherein the first control message comprises a non-access stratum service request message or a non-access stratum control plane service request message.

Aspect 7: The method of any of aspects 1 through 6, further comprising: pausing one or more operations of the UE in accordance with transmitting the first control message; and resuming the one or more operations of the UE upon transmitting the second non-access stratum message indicating receipt of the reallocation of the first temporary identifier.

Aspect 8: A method for wireless communications at a radio access network node, comprising: transmitting, to a core network node, a first control message from a UE indicating a request to terminate a paging procedure at the UE, the first control message associated with a first temporary identifier for the UE; receiving, from the core network node, a first non-access stratum message comprising a first portion and a second portion, the first portion comprising both an acknowledgement of the request to terminate the paging procedure in response to the first control message and an indication of a reallocation of the first temporary identifier, the second portion comprising a set of release assistance parameters associated with triggering a service release of the UE from the radio access network node; relaying, to the UE, the first portion of the first non-access stratum message; receiving, from the UE, a second non-access stratum message in response to the first non-access stratum message indicating receipt of the reallocation of the first temporary identifier; and transmitting, to the UE, a second control message indicating the service release of the UE from the radio access network node in accordance with the set of release assistance parameters and in response to receiving the second non-access stratum message.

Aspect 9: The method of aspect 8, further comprising: determining, from the set of release assistance parameters, that the radio access network node is to initiate the service release of the UE based at least in part on receiving the second non-access stratum message.

Aspect 10: The method of any of aspects 8 through 9, further comprising: transmitting, to the core network node, a third non-access stratum message indicating receipt of the reallocation of the first temporary identifier at the UE and indicating the service release of the UE from the radio access network node.

Aspect 11: The method of any of aspects 8 through 10, wherein the first non-access stratum message is an N2 message from the core network node comprising the reallocation of the first temporary identifier and the set of release assistance parameters.

Aspect 12: The method of any of aspects 8 through 11, wherein the first non-access stratum message includes at least one data packet for the UE, the method further comprising: receiving, from the UE, the second non-access stratum message indicating receipt of the first non-access stratum message.

Aspect 13: The method of any of aspects 8 through 12, wherein the first non-access stratum message comprises a downlink control message.

Aspect 14: A method for wireless communications at a core network node, comprising: receiving, from a radio access network node, a first control message from a UE indicating a request to terminate a paging procedure at the UE, the first control message associated with a first temporary identifier for the UE; transmitting, to the radio access network node, a first non-access stratum message comprising a first portion and a second portion, the first portion comprising both an acknowledgement of the request to terminate the paging procedure in response to the first control message and an indication of a reallocation of the first temporary identifier, the second portion comprising a set of release assistance parameters associated with triggering a service release of the UE from the radio access network node; receiving, from the radio access network node, a second non-access stratum message indicating the service release of the UE from the radio access network node in accordance with the set of release assistance parameters and in response to receiving the reallocation of the first temporary identifier.

Aspect 15: The method of aspect 14, wherein the set of release assistance parameters indicate that the radio access network node is to initiate the service release of the UE based at least in part on receiving the second non-access stratum message from the UE.

Aspect 16: The method of any of aspects 14 through 15, wherein the first non-access stratum message is an N2 message comprising the reallocation of the first temporary identifier and the set of release assistance parameters.

Aspect 17: The method of any of aspects 14 through 16, wherein the first non-access stratum message comprising the reallocation of the first temporary identifier includes at least one data packet for the UE.

Aspect 18: An apparatus for wireless communications at a UE, comprising a processor; memory coupled with the processor; and instructions stored in the memory and executable by the processor to cause the apparatus to perform a method of any of aspects 1 through 7.

Aspect 19: An apparatus for wireless communications at a UE, comprising at least one means for performing a method of any of aspects 1 through 7.

Aspect 20: A non-transitory computer-readable medium storing code for wireless communications at a UE, the code comprising instructions executable by a processor to perform a method of any of aspects 1 through 7.

Aspect 21: An apparatus for wireless communications at a radio access network node, comprising a processor; memory coupled with the processor; and instructions stored in the memory and executable by the processor to cause the apparatus to perform a method of any of aspects 8 through 13.

Aspect 22: An apparatus for wireless communications at a radio access network node, comprising at least one means for performing a method of any of aspects 8 through 13.

Aspect 23: A non-transitory computer-readable medium storing code for wireless communications at a radio access network node, the code comprising instructions executable by a processor to perform a method of any of aspects 8 through 13.

Aspect 24: An apparatus for wireless communications at a core network node, comprising a processor; memory coupled with the processor; and instructions stored in the memory and executable by the processor to cause the apparatus to perform a method of any of aspects 14 through 17.

Aspect 25: An apparatus for wireless communications at a core network node, comprising at least one means for performing a method of any of aspects 14 through 17.

Aspect 26: A non-transitory computer-readable medium storing code for wireless communications at a core network node, the code comprising instructions executable by a processor to perform a method of any of aspects 14 through 17.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for wireless communications at a user equipment (UE), comprising:
transmitting, to a radio access network node, a first control message indicating a request to terminate a paging procedure at the UE, the first control message associated with a first temporary identifier for the UE;
receiving, from the radio access network node, a first non-access stratum message comprising both an acknowledgement of the request to terminate the paging procedure in response to the first control message and an indication of a reallocation of the first temporary identifier for the UE;
transmitting, to the radio access network node and in response to the first non-access stratum message, a second non-access stratum message indicating receipt of the reallocation of the first temporary identifier; and
receiving, from the radio access network node, a second control message indicating a service release of the UE from the radio access network node in response to the second non-access stratum message.

2. The method of claim 1, further comprising:
initiating the service release of the UE from the radio access network node upon receiving the second control message.

3. The method of claim 1, wherein the first non-access stratum message further comprises at least one data packet for the UE, the method further comprising:
transmitting, to the radio access network node, the second non-access stratum message indicating receipt of the first non-access stratum message.

4. The method of claim 3, wherein the at least one data packet comprises a non-access stratum packet data unit.

5. The method of claim 1, wherein the first non-access stratum message comprises a downlink control message.

6. The method of claim 1, wherein the first control message comprises a non-access stratum service request message or a non-access stratum control plane service request message.

7. The method of claim 1, further comprising:
pausing one or more operations of the UE in accordance with transmitting the first control message; and
resuming the one or more operations of the UE upon transmitting the second non-access stratum message indicating receipt of the reallocation of the first temporary identifier.

8. A method for wireless communications at a radio access network node, comprising:
transmitting, to a core network node, a first control message from a user equipment (UE) indicating a request to terminate a paging procedure at the UE, the first control message associated with a first temporary identifier for the UE;
receiving, from the core network node, a first non-access stratum message comprising a first portion and a second portion, the first portion comprising both an acknowledgement of the request to terminate the paging procedure in response to the first control message and an indication of a reallocation of the first temporary identifier, the second portion comprising a set of release assistance parameters associated with triggering a service release of the UE from the radio access network node;
relaying, to the UE, the first portion of the first non-access stratum message;
receiving, from the UE, a second non-access stratum message in response to the first non-access stratum message indicating receipt of the reallocation of the first temporary identifier; and
transmitting, to the UE, a second control message indicating the service release of the UE from the radio access network node in accordance with the set of release assistance parameters and in response to receiving the second non-access stratum message.

9. The method of claim 8, further comprising:
determining, from the set of release assistance parameters, that the radio access network node is to initiate the service release of the UE based at least in part on receiving the second non-access stratum message.

10. The method of claim 8, further comprising:
transmitting, to the core network node, a third non-access stratum message indicating receipt of the reallocation of the first temporary identifier at the UE and indicating the service release of the UE from the radio access network node.

11. The method of claim 8, wherein the first non-access stratum message is an N2 message from the core network node comprising the reallocation of the first temporary identifier and the set of release assistance parameters.

12. The method of claim 8, wherein the first non-access stratum message includes at least one data packet for the UE, the method further comprising:
receiving, from the UE, the second non-access stratum message indicating receipt of the first non-access stratum message.

13. The method of claim 8, wherein the first non-access stratum message comprises a downlink control message.

14. A method for wireless communications at a core network node, comprising:
receiving, from a radio access network node, a first control message from a user equipment (UE) indicating a request to terminate a paging procedure at the UE, the first control message associated with a first temporary identifier for the UE;
transmitting, to the radio access network node, a first non-access stratum message comprising a first portion and a second portion, the first portion comprising both an acknowledgement of the request to terminate the paging procedure in response to the first control message and an indication of a reallocation of the first temporary identifier, the second portion comprising a set of release assistance parameters associated with triggering a service release of the UE from the radio access network node;
receiving, from the radio access network node, a second non-access stratum message indicating the service release of the UE from the radio access network node in accordance with the set of release assistance parameters and in response to receiving the reallocation of the first temporary identifier.

15. The method of claim 14, wherein the set of release assistance parameters indicate that the radio access network node is to initiate the service release of the UE based at least in part on receiving the second non-access stratum message from the UE.

16. The method of claim 14, wherein the first non-access stratum message is an N2 message comprising the reallocation of the first temporary identifier and the set of release assistance parameters.

17. The method of claim 14, wherein the first non-access stratum message comprising the reallocation of the first temporary identifier includes at least one data packet for the UE.

18. An apparatus for wireless communications at a user equipment (UE), comprising:
a processor;
memory coupled with the processor; and
instructions stored in the memory and executable by the processor to cause the apparatus to:
transmit, to a radio access network node, a first control message indicating a request to terminate a paging procedure at the UE, the first control message associated with a first temporary identifier for the UE;
receive, from the radio access network node, a first non-access stratum message comprising both an acknowledgement of the request to terminate the paging procedure in response to the first control message and an indication of a reallocation of the first temporary identifier for the UE;
transmit, to the radio access network node and in response to the first non-access stratum message, a second non-access stratum message indicating receipt of the reallocation of the first temporary identifier; and
receive, from the radio access network node, a second control message indicating a service release of the UE from the radio access network node in response to the second non-access stratum message.

19. The apparatus of claim 18, wherein the instructions are further executable by the processor to cause the apparatus to:
initiate the service release of the UE from the radio access network node upon receiving the second control message.

20. The apparatus of claim 18, wherein the first non-access stratum message further comprises at least one data packet for the UE, and the instructions are further executable by the processor to cause the apparatus to:
transmit, to the radio access network node, the second non-access stratum message indicating receipt of the first non-access stratum message.

21. The apparatus of claim 20, wherein the at least one data packet comprises a non-access stratum packet data unit.

22. The apparatus of claim 18, wherein the first non-access stratum message comprises a downlink control message.

23. The apparatus of claim 18, wherein the first control message comprises a non-access stratum service request message or a non-access stratum control plane service request message.

24. The apparatus of claim 18, wherein the instructions are further executable by the processor to cause the apparatus to:
pause one or more operations of the UE in accordance with transmitting the first control message; and
resume the one or more operations of the UE upon transmitting the second non-access stratum message indicating receipt of the reallocation of the first temporary identifier.
